(19) United States
(12) Patent Application Publication
(10) Pub. No.: US 2008/0092087 A1
(43) Pub. Date: Apr. 17, 2008

(54) Method and Display Data Entry Unit

(76) Inventors: Ronald Brown, Morgan Hill, CA (US); Daniel Harden, Palo Alto, CA (US)

Correspondence Address: BOYLE FREDRICKSON S.C., 840 North Plankinton Avenue, MILWAUKEE, WI, 53203, US

(21) Appl. No.: 11/857,435

(22) Filed: Sep. 18, 2007

Related U.S. Application Data
(63) Continuation-in-part of application No. 11/374,291, filed on Sep. 19, 2005.
(60) Provisional application No. 60/845,373, filed on Sep. 18, 2006.
(60) Provisional application No. 60/846,365, filed on Sep. 20, 2006.

(51) Int. Cl. G06F 3/033

(52) U.S. Cl. 715/863

(57) ABSTRACT

A display data entry unit and method of configuring and operation of a display data entry unit composed of one or more display-containing data inputs that, in a preferred embodiment, include one or more depressible display-equipped keys. The unit can interface with an API that changes images shown on display keys and their associated executable functions based on contextual user interaction with a software application run on the device to which the unit is linked. In one preferred implementation, a browser module or plug-in is employed that monitors websites and causes corresponding image and executable function changes in one or more of the display keys of the unit based on the website being browsed. In one preferred implementation, the browser module or plug-in parses each web page navigated by a browser and causes such changes to automatically occur based on web page content.

### CROSS REFERENCE TO RELATED APPLICATION(S)

This application is a continuation-in-part of U.S. application Ser. No. 11/374,291 and this application also claims priority under 35 U.S.C. Section 119(e) in U.S. Provisional Application Ser. No. 60/845,373, filed Sep. 18, 2006, and in U.S. Provisional Application Ser. No. 60/846,365, filed Sep. 20, 2006, the entire disclosures of each which are expressly incorporated herein.

### FIELD

The present invention is directed to methods for display data entry units and more particularly to methods relating to the configuration, use, and operation thereof.

### BACKGROUND

Human input devices are commonly used to enable a user to affect operation of an apparatus that typically is equipped with a processor, storage, and a source or supply of electrical power. Such input devices include text input devices, pointing devices, gaming devices, imaging input devices, video input devices, audio input devices, and the like. Examples of text input devices include keyboards, keypads and the like. Examples of pointing devices include a mouse, trackball or roller ball, pointing stick, joystick, touchpad, graphics tablet, and the like. Examples of gaming devices include a game console, e.g., game pad or joy pad, paddle, joystick, keyboard, remote, and the like. Examples of image and video input devices include a scanner, camera, video recorder, web cam, and the like. Examples of audio input devices include a microphone, recorder, and the like.

Despite the rather abundant variety of input devices that exist today, entry and manipulation of data is still rather cumbersome, relatively slow, and inefficient. Oftentimes the biggest limitation relates to the complexity of the device or software with which the user must interact. While more efficient ways of using the device or software exist, it often takes a great deal of time, in some instances training, for the user to become more proficient. Unfortunately, even where this occurs, the user is often just scratching the surface of how to use the device or software most efficiently.

Quite often, there are tips, tricks, and shortcuts available that can save a great deal of time and effort. Unfortunately, because of the inherent complexity of these devices and software, the task of memorizing them is often impossible if not unmanageable. A prominent example of such software is Microsoft Word, one of the most commonly used software applications in the world. Because it has over 900 shortcuts using key combinations and macros, it is no wonder that the typical user struggles just to achieve a basic level of proficiency. Over time, a typical user may end up memorizing, at the very most, a few dozen shortcuts and macros.

Where on-screen help is available, it can provide useful guidance to the user that can help make use easier, faster and more efficient. However, at some point, productivity gains end up being lost if the user has to resort to calling up onscreen help too frequently. This can also interfere with completing the task at hand, especially where on-screen help ends up obscuring other on-screen data of interest to the user.

What is needed is a display equipped data entry unit that is more efficient in use and operation.

### SUMMARY

One aspect of the present invention includes a display key that has an outer keycap that has a top surface equipped with a display window through which a key display can be viewed by a user of a device to which the display key enables data input. The keycap assembles to a key body such that a display assembly or display module is housed inside. In a preferred display key assembly arrangement and method, the display assembly is manipulated so it is between the body and keycap before snapping the keycap and body together around the display assembly.

In one preferred display keycap embodiment, the display keycap has a top wall dimensionally smaller than that of its open bottom with a plurality of sidewalls that taper inwardly from the bottom to the top wall. Particularly where used for PC applications, the top surface of the top wall is concave and has a window formed in it through which the key display is visible. The keycap top wall and sidewalls are typically opaque.

Where opaque, the window can be physically formed, e.g., molded, in the top wall such that it extends completely through the top wall. The keycap top wall that remains borders or frames the display window providing contact surface area that helps transfer force applied against the display key to the keycap and away from the display. Where the window is physically formed in the keycap top wall, a protective layer and/or coating can overlie the key display. Such a protective layer and/or coating can be used to make the region of the top surface of the keycap top wall substantially flush with the top surface of the part of the top wall that borders or frames the display window.

In one preferred keycap embodiment, the keycap is constructed so as to receive and retain the key display. The keycap has a key display receiving pocket in which the key display is received. The pocket includes one or more channels or slots integrally formed in part of the keycap, namely the top wall, which slidably receives the display. The channels or slots are substantially parallel and are formed in opposite border or frame sides of the keycap top wall. The mouth or entrance of the pocket can be covered by a separate component that functions as a retainer that retains the display in the pocket. Where such a separate retainer is used, it snaps into a recess at or adjacent the mouth or entrance of the display-receiving pocket.

The display key body has a base that provides a seat for at least a portion of the key display assembly or key display module. In one preferred embodiment, part of the display assembly/module can rest against or seat on an interior surface of the base such that it least part of the display assembly/module is bounded by one or more upraised lips that encompass part or all of the periphery of the base. One or more lips extend along at least a plurality of opposed sides of the display assembly/module as well as at least one of the sides of the base angled relative thereto. In another preferred embodiment, the base of the body includes an upraised cradle defined by a pair of elongate supports that each includes an integrally formed display assembly/module recess.

Either or both of the keycap and the display key body include a plurality of snap hooks that are received in a corresponding recess formed in the other component to snap these two components together. In a preferred embodiment, the keycap and the display key body have a plurality of hooks as well as a plurality of hook-receiving recesses.

One preferred display assembly includes a display circuitry, which can be a module that includes circuitry located onboard a circuit board or the like disposed adjacent the display key body when the display key has been assembled. The display circuitry includes display driver circuitry and can include a backlighting arrangement where backlighting is desired. The display circuitry can also include display image data memory as well as a processor, such as a microprocessor, microcontroller, or the like.

Where backlighting is used, a diffuser is located within the display key between the display circuitry and the display. There is a link between the display circuitry onboard the display key and the display that includes a cable, such as a multi-conductor ribbon cable, and one or more connectors each of which can include one of a plug and complementary mating socket.

There is another link constructed and arranged to communicate key display control signals as well as electrical power to the display assembly/module of the display key. In one preferred embodiment, the link is a cable that extends to the outside of the display key and can include one or more electrical connectors. Such a link also includes a like cable and can also include one or more electrical connectors of the same or similar type. In another preferred embodiment, control signals are communicated via the plunger, through conductors and/or contacts carried by, embedded in, or otherwise disposed onboard the plunger.

A preferred display key embodiment constructed in accordance with the invention is of such compact construction that it is particularly well suited for keyboards, including PC keyboards, PDA keyboards, notebook computer keyboards and the like. One preferred display key construction is of standard PC key height, width, and depth and one preferred display keyboard is a Qwerty style PC keyboard that has, for example, anywhere from 100 or more keys. One preferred display PC keyboard is a keyboard of standard size keyboard that is equipped with one, two, three or more display PC keys and can be constructed so that non-display keys can be removed and replaced with display PC keys.

The image displayed on each display key is changeable, such as in response to context and situational operations. Software onboard the device to which the display key is linked controls what image is displayed and when, with images being changeable in real time during device operation, including changes being made in response to interaction with the device and/or display key by the user. The same holds true for each display key where a plurality of display keys are linked to a device, such as via a display PC keyboard linked to a computer.

Display image data can be provided to a display key that causes its display to show a letter, a number, a plurality of letters and/or numbers, alphanumeric commands that can include one or more displayed words, a picture, a symbol, an icon, or some other visually perceptible indicia. The advantageous construction of the invention is very different than conventional keyboards equipped with so-called “programmable” keys, which assign one function to a particular programmable key, usually requiring considerable effort on the part of the user to do so. In another aspect of the invention, software run on the device is able to directly or indirectly cause one or more display keys to change what they display, including in real-time, based on what the user needs, wants, or is likely to do, advantageously resulting in fewer menus to navigate and fewer commands that need to be remembered. This results in reduced learning time, fewer input errors, and more logical presentation of information, including selection choices, to the user, and speedier user input, all of which advantageously increases accuracy and efficiency. For example, rather than memorizing more commands, a user can be shown only the context-applicable command, command-related information or shortcut, either in alphanumeric or symbolic form, that is needed for the user to make a decision or selection. Because of software's ever increasing complexity, an input device that utilizes PC key-sized display keys constructed in accordance with the invention bridge the gap providing an elegant, simple and familiar solution to software users.

Such software can be configured to directly or indirectly cause the image displayed by one or more display keys to change. For example, in one preferred implementation, display keys can be programmed and/or changed via client software, server software, both, as well as via the Internet, alone or in combination with client software and/or server software. Display key image control software can be in the form of the software program being run by the user, an API that interfaces with the program, a plug-in software module, such as an Active-X plug-in, an add-on, such as a browser add-on, or another type of software that can run in the foreground and/or background. In addition, such software can be configured to allow a user to create custom display key images as well as to change which display key is assigned which particular function or command.

In one preferred method, one selection or choice, whether it be by pressing a key, including a display key, or on-screen, such as by using a mouse and/or making a menu selection, causes the display of at least one display key to change in anticipation of what selection(s) the user will encounter next or is likely to want available at that point. Animation of a single display of a single display key or of the displays of a plurality of pairs of display keys can be done, including via software control, during operation.

The present invention is also directed to a display-equipped key assembly well suited for use in a wide variety of processing devices, such as computers, mobile phones, game consoles, and the like, in which the display key housing is of multi-component snap together construction. In a preferred embodiment, the housing is formed by a display keycap configured to facilitate image viewing from an image generated by a display, such as an LCD display or the like, that is captive within the display key assembly. The display keycap mates with a key base having an integral key switch actuating plunger that can be of conventional plunger construction for enabling a display key constructed from a display key assembly in accordance with the invention to be used with existing key switch designs, including those which include a membrane (not shown) or the like. The keycap and base are configured so as to snap together around the display while including onboard integral structure that helps orient and/or locate the display.

In one preferred embodiment, the base includes an integral cradle in which display components seat within the housing formed from assembly of the keycap and base. In a preferred embodiment, the keycap and base include integrally formed interlocking engagement structure enabling them to snap together to form a display key assembly that is of simple, economical, durable and robust construction. In one preferred embodiment one or both the keycap and base have snaps, such as cantilever snaps, that engage via a snap fit to positively assemble the components together to form a display key. In another preferred embodiment, a plurality of integral tabs of the keycap or base is received in complementary tab-receiving pockets formed in the base or keycap enabling the keycap and base to be snapped together.

In a preferred embodiment, the display key assembly includes onboard circuitry including one or more of a display driver, display controller, transducer, backlight or another component that is retained along with the display captive between the keycap and base when the keycap and based are assembled. In one preferred embodiment, an integral seat formed in the base receives a circuit board carrying one of the driver, controller, transducer or backlight with the seat locating the circuit board and display within the display key assembly formed by engaging the keycap with the base. A cable, such as a ribbon cable, extends from a display module to the onboard circuit board. A second cable can extend from the circuit board to an off-board controller, e.g., controller circuit board, of the data input device or the processing device to which the data input device is linked.

In one preferred embodiment, power and data are delivered from the controller board to the display via integrally disposed conductors carried by or integral with the plunger. In a preferred controller arrangement, key display image data is sequentially communicated via a bus connecting all of the display keys of a display key equipped data input device such that display image data order determines which display key displays which image data.

It is an advantage that a PC display keyboard constructed in accordance with the invention is capable of using a standard keyboard controller such that display key ID's remain the same as that used in conventional non-display keyboards presently in use. In a preferred embodiment, a standard keyboard controller is employed.

It is another advantage that a great deal of the hardware and the like already used in existing non-display PC keyboards can be utilized in a display PC keyboard that is constructed in accordance with the invention.

It is still another advantage that a display PC keyboard constructed in accordance with the invention is able to take advantage of existing product form factors, standardization, because people are already familiar with using keyboards, and user familiarity.

It is a still further advantage to provide a display key and/or key display that is well suited for numerous applications, including for example Internet navigation and contingent changing of key display images based thereon, and devices, such as personal computers, PDAs, mobile phones, e.g., cellular phones, notebook computers, sub-mini computers, satellite radio, satellite controlled/interactive appliances, on-board vehicle user control panels (e.g. to control heat, radio, seat settings, vehicle operation, etc.), etc.

It is another advantage that a display PC keyboard can be provided where the displays of the display keys can be configured to display a plurality of different languages such as via selecting a different language in the device operating system, via user selection, via software program control, etc.

It is another advantage that special software commands can be highlighted by providing appropriate key display images at the appropriate time during program execution.

It is still another advantage that logos can be displayed on key displays of display keys for advertising purposes, to be directed to the company associated with a particular key-displayed logo by sending the user to their website, etc.

It is still another advantage to be able to block out or black out certain display keys, such as when a user is not authorized to use them.

It is an object of the present invention that key display image data and/or display key configuration data can be provided over the Internet, via a network, via a software program currently being executed by a user, via interface software, such as an API, that communicates with a current user executed software program, via SMS, via HTML, via XML, via ASP, via ULTRA-WIDEBAND wireless communication, via BLUETOOTH, via a SMARTCARD, via a MEMORY STICK, via an SD card, via an XD card, via a cellular network, via satellite communication, via RF-ID or an RF-ID reader, etc.

It is an advantage of the present invention to provide a display key of standard PC key form factor and travel.

Objects, features and advantages include at least one of the following: providing a display key, data input device and device controlled thereby that is simple to implement, quick, labor-efficient, economical, and which requires relatively simple skills to perform.

Various features and advantages of the present invention will also be made apparent from the following detailed description and the drawings.

### BRIEF DESCRIPTION OF THE DRAWINGS

Preferred exemplary embodiments of the invention are illustrated in the accompanying drawings in which like reference numerals represent like parts throughout and in which:

FIG. 1 is a perspective view of a data entry keyboard typically used with personal computers and the like;

FIG. 2 is an enlarged fragmentary perspective view of a plurality of pairs of display-equipped keys of the keyboard of FIG. 1;

FIG. 3 is an enlarged fragmentary perspective view of a plurality of pairs of display-equipped keys of the keyboard of FIG. 1 with the keyboard configured so as to include non-display equipped keys;

FIG. 4 is a fragmentary perspective view of a preferred embodiment of a display key;

FIG. 5 is a top plan view of a preferred embodiment of a display key assembly;

FIG. 6 is cross sectional view of the display key assembly of FIG. 5;

FIG. 7 is an exploded view of the display key assembly of FIG. 5;

FIG. 8 is an exploded side elevation view of another preferred embodiment of a display key assembly;

FIG. 9 illustrates a perspective view of a preferred embodiment of a display key assembly having a housing that is at least partially transparent for providing increased clarity;

FIG. 10 is a perspective view of the display key assembly of FIG. 9;

FIG. 11 is a drawing showing a top view of a preferred embodiment of a display key assembly overlying a cross sectional view of the display key assembly assembled to a portion of a keyboard or the like;

FIG. 12 depicts a front view and a side view of a preferred cable arrangement used to convey electronic signals to and/or from the display of the display key;

FIG. 13 illustrates a side view of a PC keyboard equipped with at least one display key having a portion of the keyboard housing broken away to show components of the display key;

FIG. 14 is similar to FIG. 12 except that it shows additional drawings that help better illustrate a preferred embodiment of how such a display key and display key switch can be mounted to or carried by a data entry device such as a PC keyboard or the like;

FIG. 15 illustrates a top plan view of a PC keyboard equipped with a plurality of pairs of function keys each being of display key and display key switch construction;

FIG. 16 illustrates an exploded view of another preferred embodiment of a display key assembly;

FIG. 17 is a top view of a display key constructed in accordance with that depicted in FIG. 16 showing the key display removed;

FIG. 18 is a top view of the display key of FIG. 17 showing the key display;

FIG. 19 is a top perspective view of the display key of FIG. 16;

FIG. 20 is a side perspective view of the display key of FIG. 16;

FIG. 21 is a perspective cross section view of the display key cap of FIG. 16;

FIG. 22 is a cross sectional view of the display key cap of FIG. 16;

FIG. 23 is a bottom plan view of the display key cap of FIG. 16;

FIG. 24 is an enlarged fragmentary bottom perspective view of the display key cap of FIG. 16;

FIG. 25 is a top perspective view of the top of the body of the display key assembly shown in FIG. 16;

FIG. 26 is a side perspective view of the body of the display key assembly of FIG. 16;

FIG. 27 is a second side perspective view of the body of the display key assembly of FIG. 16;

FIG. 28 is a top perspective view of the top of the body of the display key assembly of FIG. 16;

FIG. 29 is a second top perspective view of the top of the body of the display key assembly of FIG. 16;

FIG. 30 illustrates a side perspective view of the body;

FIG. 31 is a schematic of a preferred display data input device controller arrangement;

FIG. 32 is a perspective view of a display key equipped game controller;

FIG. 33 is a screen shot of a preferred embodiment of a display key layout image editor and image display editor; and

FIG. 34 is a screen shot of a software representation of a display keyboard configured in accordance with the present invention.

Before explaining one or more embodiments of the invention in detail, it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

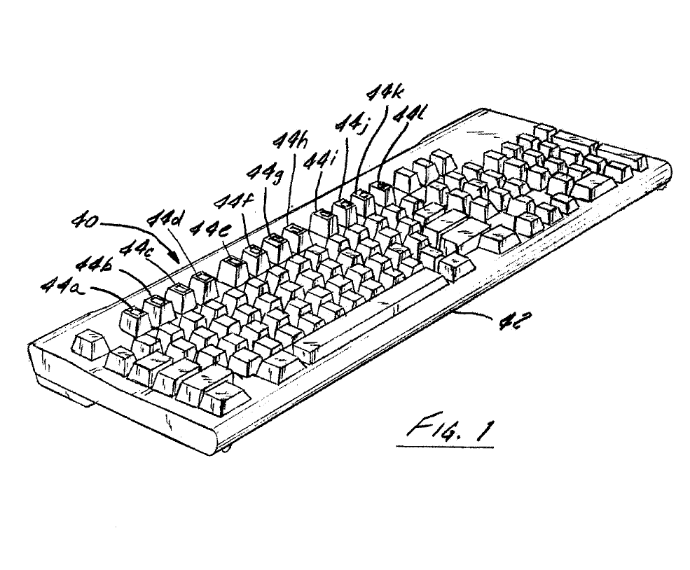

FIG. 1 illustrates a preferred embodiment of a data entry device that is equipped with a plurality of pairs (e.g., three or more) of display keys 44 constructed in accordance with the invention. The data entry device depicted in FIG. 1 is a display keyboard 40, such as a computer keyboard for a computer that can be a personal computer, personal data assistant, or the like. As is shown in FIG. 1, the display keyboard 40 has a plurality of rows of keys carried by a keyboard housing 42.

However, it should be understood that one or more of the various aspects of the inventions disclosed herein are not just well suited for PC keyboard use but also for other types of devices and applications. For example, one or more display keys along with associated components, including hardware, circuitry, firmware/software, interfacing, and the like in accordance with such disclosed herein can be used in devices such as digital cameras, video cameras, PDAs, mice, scanners, drawing pads, game consoles, joy sticks, cell phones, mobile phones, telephones, televisions, video disk players, VCRs, routers, switches, servers, power strips, surge suppressors, power line conditioners, industrial switching and power regulating equipment (e.g. transfer switches, etc.), bar code readers, digitizers, musical instruments (e.g., synthesizers, digital keyboards, digital pianos, electronic drum sets, etc., loud speakers, home entertainment centers and systems, digital media players (e.g., MP3 players, CD players, etc.), copiers, fax machines, key pads, GPS units, beepers and other messaging units (e.g. hand-held and personal messaging units), notebook and other portable computers, modems, industrial and factory equipment (e.g., machine tools, conveyors, factory automation equipment, logistics-related equipment, warehouse/inventory related equipment, etc.), to name but a few. However, for purposes of disclosing at least preferred embodiment, a PC keyboard is disclosed herein below.

In the preferred keyboard depicted in FIG. 1, every key is a display key 44 except for example the Tab key, the Caps Lock key, the Shift keys, the Control (Crtl) keys, the Alt keys, the Space key or Spacebar key, the Backspace key, and the Enter keys. If desired, other keys, such as the Windows key (where so equipped), the menu pull-down key (where so equipped), the Escape key, and/or financial operator keys can be non-display keys. In a like manner, where the keyboard is configured for a different type of computer, such as a computer made by Apple Computer, non-alphanumeric keys need not be display equipped. However, it should be kept in mind that one or more of such non-alphanumeric keys can be of display key construction if desired.

In the preferred keyboard depicted in FIG. 1, the keyboard is a display keyboard 40 that has a plurality of rows and columns of display keys 44. In the preferred display keyboard depicted in FIG. 1, the display keyboard has a plurality of pairs of rows and columns of alphanumeric keys being display key equipped (such as shown in FIG. 1). The display keyboard can be configured so that one or more of the key receivers for the non-display keys 46 (FIG. 3) is display key capable or display key enabled. However, if desired, a display keyboard constructed in accordance with the invention can have only its function keys (e.g., FIG. 3) equipped with display keys. If desired, one or more of the non-display keys 46 can be received in mounts, sockets, or the like of the keyboard that are of display key capable construction.

Display key capable/enabled means that a particular non-display key 46 can be removed and replaced with a display key 44. In this regard, such a keyboard can be configured with none, one, a pair, or even more display keys 44 and can be modified, such as by the end-user, by or for an original equipment manufacturer, by or for a specialty equipment manufacturer (such as a graphics card maker, specialty board maker, or the like), by or for a software maker, by or for a distributor, by or for an integrator, by or for a hardware manufacturer, etc.

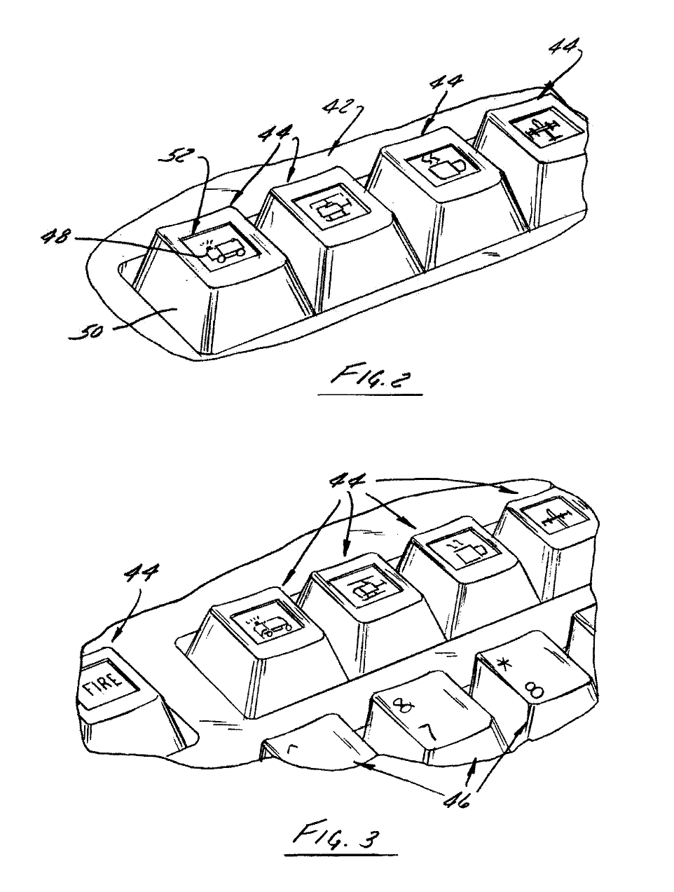

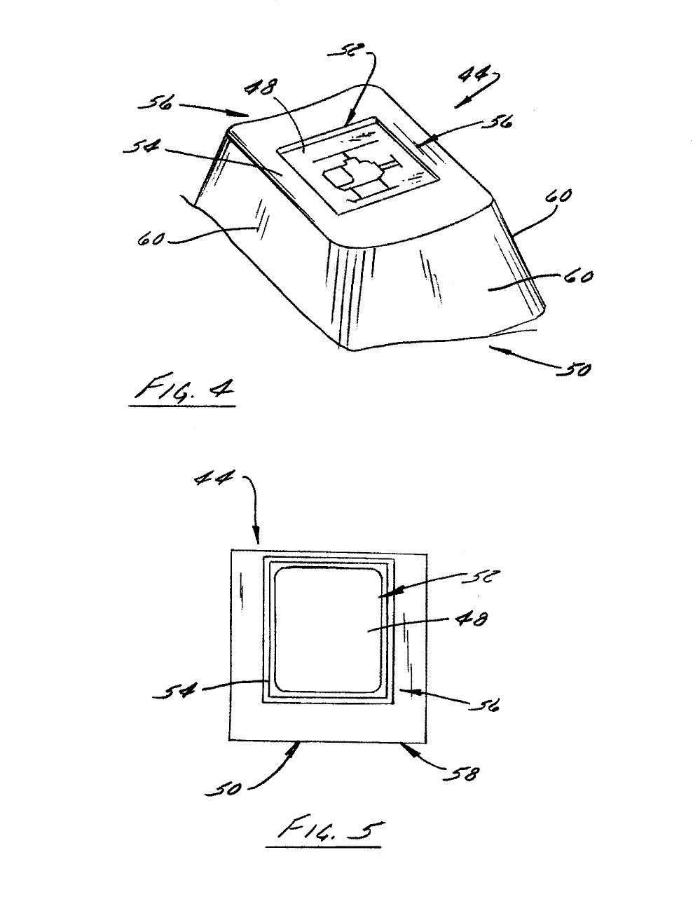

FIG. 2 illustrates a plurality of pairs of display keys 44 arranged in a row, such as part of the row of function keys disposed along the top of the keyboard shown in FIG. 1. Referring additionally to FIGS. 3 and 4, each key 44 is equipped with a display 48 on which a character, symbol, picture, graphic, or other indicia can be shown thereon. For example, the leftmost key is equipped with a display currently configured to show a picture of a fire truck, the key adjacent is equipped with a display currently configured to show a picture of a helicopter, the next key is equipped with a display currently configured to show a mug or cup, and the rightmost key is equipped with a display currently configured to show an aircraft or the like.

Each key display 48 is carried by part of a key cap of the display key 44. In the preferred embodiment shown in FIGS. 2-4, the display 48 is positioned so as to be exteriorly visible to a user via a window in the top surface of the key, which is pressed by the user during selection of that particular key. Each key display 48 can be selectively configured to show such a character, symbol, picture, graphic, or other indicia as desired. In addition, each key display 48 is re-configurable, such as where is it is desired to change what is displayed by the key display 48.

Each key display 48 has a resolution of at least a plurality of pairs of dots or pixels by at least a plurality of pairs of dots or pixels (i.e. at least 3×3 or more). In a preferred embodiment, each key display has a resolution of at least 16 by 16 dots or pixels with each dot or pixel being of 1 bit (i.e. on or off) depth. In one preferred embodiment, where the key display is of grayscale or monochrome construction, each dot or pixel is of at least 6 bit depth and preferably of 8 bit depth thereby being capable of displaying as many as 256 different shades for each dot or pixel of the key display. Where the key display is capable of displaying colors, each dot or pixel preferably is of a color bit depth of 6 bits or greater. In one preferred embodiment, a color key display is used that is capable of displaying between 16 million and 16.7 million colors. In a preferred embodiment, each key display is a 20×20 display that is of LCD construction.

The key display 48 is an electronically controllable display panel. The preferred embodiment depicted in FIGS. 1-3 has generally rectangular shape and has a substantially flat or planar outer display surface. In a presently preferred embodiment, the key display is of liquid crystal diode construction (LCD) that provides grayscale or monochrome output during operation. In another preferred embodiment, the key display is of light emitting diode construction, such as organic light emitting diode (OLED) construction. OLED displays offer advantages that include being inherently more emissive, which can reduce or eliminate the need for backlighting, and need not be flat or planar in shape. In this same regard, an organic light emitting polymer (OLEP) display can also be used as the display.

In one preferred embodiment, control of what is shown on one or more key displays 48 of one or more display keys 44 is done via software, such as by software being executed by the device being controlled by the keyboard 40. For example, where the device being controlled is a personal computer, a software program being run by a user controls what is shown on one or more key displays of one or more display keys of the display keyboard. It does so or is capable of doing so for each display key. Such a software program advantageously provides the capability for the user to configure what is displayed on a particular key display of a display key at a particular time, during a particular condition, and/or to control a particular function or selection.

While such software can be an integral part of the software program run by the user, the software can also be implemented as a module that interfaces with the software program run by the user. Such interface module software can operate in the background and simply hook with a particular software program run by a user when that particular software program is run by the user. For example, where a particular software program designed to hook with or otherwise cooperate with key display configuration interface software is a game, such as DOOM, FAR CRY, SOLDIER OF FORTUNE, HALO, UNREAL, etc., the key display configuration interface software can be configured with default key display configuration data for each display key of the display keyboard that is generally applicable to all software, that is specific to the game being run by the user, and/or which receives key display configuration data from the game during or after it is run by the user.

Such software games can be self-contained, such as by being run and played only on a single device. They also can be networked or networkable games, such as games that interface or originate via the Internet. An example of one type of game for which a display keyboard, keypad, game console, and/or joystick equipped with one or more display keys constructed in accordance with the invention is particularly well suited include networked games that include massively multiplayer online role playing games (MMORPG), such as EVERQUEST and the like. One or more key displays can be configured and/or otherwise controlled via signals and/or data received via the network via which the networked game is played. Such interaction is not limited only to games as networked and/or networkable applications can also interface and cooperate in like manner with a display keyboard, display keypad, custom configured input console and the like.

Such key display configuration data interface software can be implemented as, controlled by or include an application program interface (API). Where implemented in this manner, such key display configuration data interface software exists as a software layer, such as a process or thread, which is between the operating system of the device being controlled by the display keyboard and the application program run by the user. Such a display data entry unit API provides an interface between a software application, such as Microsoft Word, a software game, a browser, or the like, and the operating system thereby enabling user interaction with the program to cause a change in the images displayed by one or more display keys 44 of a display-equipped data entry unity, e.g. display key equipped keyboard 40. This same API or a different API can, in turn, receive and interpret key press data from one or more display equipped keys pressed by a user and carry out a desired function or action. It can also cause a software application with which it interfaces to carry out a desired function or action based upon key press data generated from a user pressing one or more display equipped keys engaged by the user.

In one preferred implementation, such key display configuration data interface software installs automatically when a display keyboard is attached to a device, such as a computer. Where the device being controlled is plug-and-play compatible or enabled, the key display configuration data interface software installs as part of the display keyboard installation process. In one preferred implementation, this includes installation of a device driver that provides or helps provide such a key display configuration data interface. In another preferred implementation, the key display configuration data interface is installed as a software program that is automatically run when the device being controlled is started, booted up and/or rebooted. In a preferred implementation, driver installation provides a display keyboard driver with a display data entry unit API or installs one or more desired display data entry unit APIs that provide communication between software applications, such as Microsoft Word, Excel, gaming software, a browser or the like, and a display key equipped keyboard connected to the device.

If desired, the interface can be or include a module, such as a plug-in, macro, or the like, which is specifically tailored for a particular program. For example, the interface can include a VB macro, such as a Word macro or the like. Where a browser is used, such as Internet Explorer, Mozilla, Firefox, Netscape or the like, the interface can be or include a plug-in or browser add-on, such as a browser helper object, a browser extension, or an active-X control. Such an interface is configurable to accept key display data and key display configuration data via the Internet, from a server, such as a network server, or via a network. For example, where a browser is executing something in Java, JavaScript, ASP, or the like, either synchronously or asynchronously, it can be configured in a manner that controls what is displayed on a key display of one or more display keys of a display keyboard of the device, e.g., computer, to which the display keyboard is connected.

Where the display keyboard is not integral with the device, e.g., not built into the device, the display keyboard communicates with the device via a link that can be a cable link, a wireless link, or another type of link. Wireless links include Bluetooth, a radio frequency wireless link, a cellular link, an infrared link, or another type of wireless link. Where a wireless link is used, a transceiver, receiver, radio, etc. facilitating the link can be built into both the display keyboard and the device. Where not built into the device, it can be constructed such that it plugs into a USB port, a Firewire port, an HDMI port, a parallel port, a serial port, or another type of port.

Where a cable link, wire link or another type of direct physical connection link is used, it can be a parallel or serial link, such as a USB link, a Firewire link, a HDMI link, or the like. Where the link is a USB link, it preferably is a USB 2.0 link or greater such that the bandwidth between the display keyboard and the device is greater than 12 Mbps.

As previously mentioned, FIG. 2 illustrates a row of display keys each equipped with a configurable display disposed in the top surface of the key cap of the display key. Each display key is constructed and arranged to be the pressed manually by a user pressing it down until a switch mechanism of the key switch of the display key closes and makes electrical contact. This causes a signal, such as an electrical signal, to be communicated to the device to which the display keyboard is connected. While it is contemplated that a display key and display key switch constructed in accordance with the invention employs a mechanical or electromechanical switch, including those of conventional construction, it should be understood that other types of switches and switching technology, such as optical switching technology, capacitance switching technology, or the like, can be used.

The display of each display key is anchored or attached in a manner such that it moves substantially in unison with the keycap of the display key. The display is fixed so as to move substantially in unison with the keycap of the display key. In the preferred embodiment depicted in FIGS. 2-4, the display is fixed to the keycap by being mechanically constrained thereto, such as by being part of a keycap assembly. If desired, the display can be fixed to the keycap by bonding, by use of a hook and loop fastener, and/or by virtue of some sort of a fit or engagement between the display and the keycap or keycap assembly.

With specific reference to FIG. 4, the top surface of the keycap 50 includes a window 52 through which the display 48 is exteriorly visible. The top surface frames the display 48 such that it has a top border, a bottom border and a pair of spaced apart side borders that form the display window 52. The display window 52 extends completely through the top surface of the keycap 50. Constructing the top surface of the keycap 50 with a border 54 advantageously helps reduce the amount of force that is actually transmitted directly to the display 48 when a user is pressing the display key 44 because a substantial portion of that force is instead transmitted to the border, and hence, the rest of the keycap 50 and display key assembly 44.

The outer surface of the display 48 can be and typically is slightly offset relative to the top surface 56 of the keycap such that the outer surface of the display is recessed. Where this is the case, a protective coating or layer can be situated over the display. The protective coating or layer can be configured to provide a thickness that makes it flush with the display border 54 defined by top surface of the keycap surrounding the display. In one preferred embodiment, the protective coating or layer is comprised of plastic, glass, and/or epoxy. The protective coating or layer preferably is transparent.

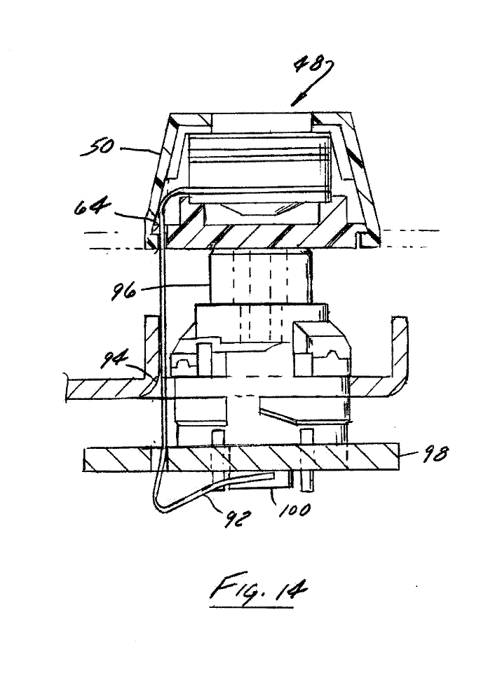

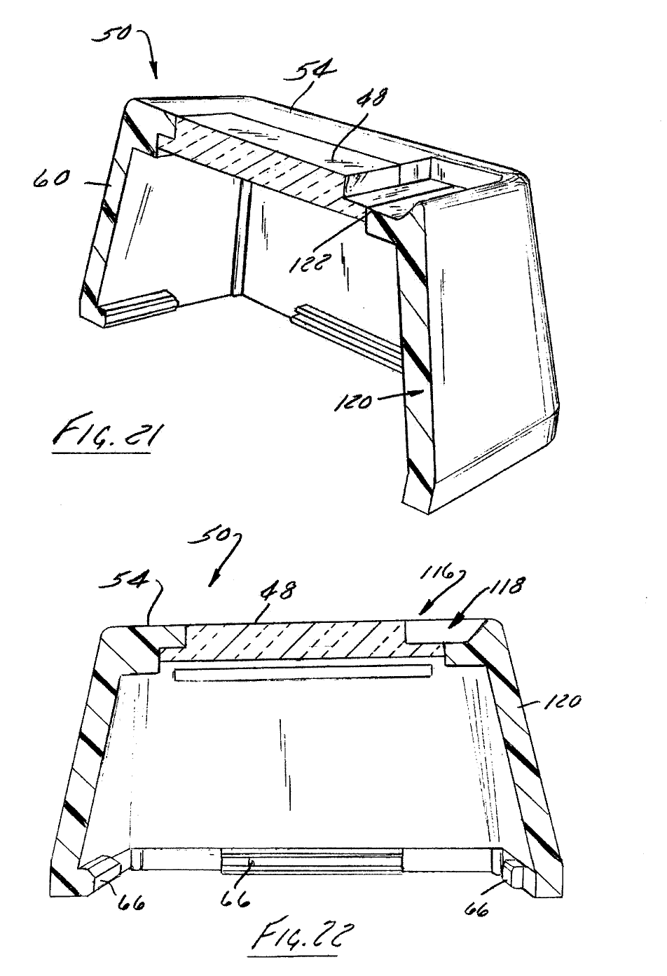

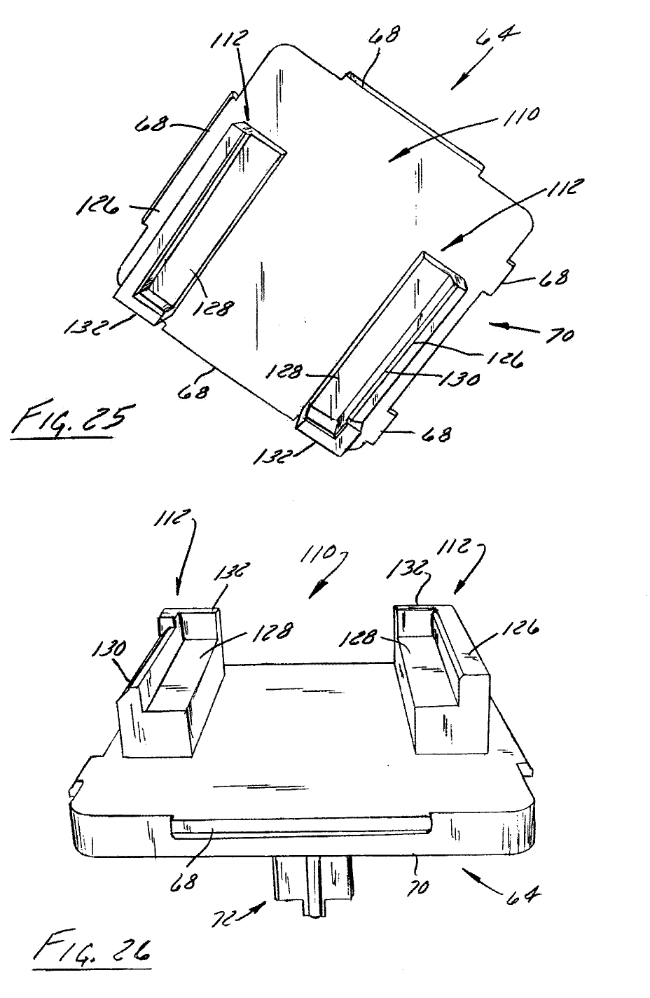

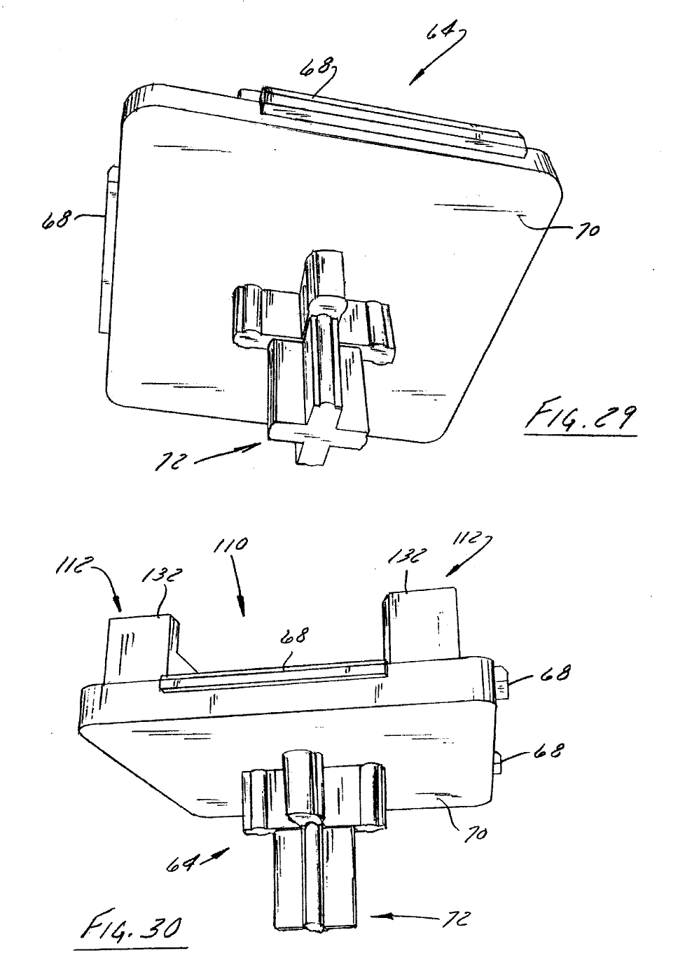

Referring additionally to FIG. 5, a display key and display key switch constructed in accordance with the present invention advantageously has a small form factor such that it can be employed in place of conventional PC keyboard keys and PC key switches. While display key switches are known, it is believed that no such known display key switch has been heretofore made sufficiently small to be used with a PC keyboard. It has not been a matter of simply shrinking components of a conventional display key switch to produce a display key and display key switch of the present invention, but rather, among other things, arranging components to achieve the small form factor configuration needed to achieve a suitably small display key and display key switch capable of use in a PC keyboard. These aspects are disclosed in more detail herein, including in FIGS. 1-30 and the text presented below.

As is shown in FIG. 5, where configured for PC use, the display keycap 50 has a suitably small form factor such that it has a height no less than 16 mm and no greater than 19 mm and a width no less than 16 mm and no greater than 19 mm. In one preferred embodiment, the display keycap 50 is substantially square with a maximum height and width no greater than 19 mm by 19 mm and no less than 16 mm by 16 mm. The sides 60 of the display keycap 50 taper from its bottom 58 to its top surface such that the height and width encompassed by the top surface is smaller than the base. In one preferred embodiment, the base has a height and width of about 18 mm by 18 mm and a top surface has a height of between 11 mm and 19 mm and a width between 9 mm and 12 mm.

The window 52 in the keycap top surface 56 and/or display 48 of the preferred embodiment depicted in FIG. 5 has a height no greater than about 12.87 mm and a width no greater than about 10.87 mm. In another preferred embodiment, the height is at least 6 mm and no greater than 14 mm and a width of at least 6 mm and no greater than 12 mm. For example, referring to FIG. 14, the window/display has a height of about 6 mm and a width of about 8 mm within a range of ±1 mm.

FIG. 6 illustrates the display key assembly 44 in more detail. The display key assembly has a display keycap depth of no more than 10 mm and about 9.4 mm. The display key assembly has a depth that is no more than 23 mm and about 20.28 mm. The display key assembly has a depth that is at least as great as about the depth of the display keycap.

Referring additionally to FIG. 7, the display keycap 50 is of one-piece, unitary and homogenous construction that preferably is molded of plastic, such as ABS or another suitable plastic. The body of the display key assembly 44 is also of such construction and is also molded out of ABS or another suitable plastic.

The keycap 50 and body 64 are configured to snap together, sandwiching a key display assembly 62 between them such that the key display assembly 62 is housed within a display key housing formed by the keycap 50 and body 64. One of the keycap 50 and body 64 includes an outwardly projecting snap-fit hook and the other one of the keycap and body has a snap-fit hook receiving recess formed therein. In the preferred embodiment shown in FIGS. 6 and 7, the keycap 50 has a pair of spaced apart and opposed sidewalls that each has a hook 66 projecting from its interior sidewall surface that is received in a corresponding recess formed in a base 70 of the body 64 that is formed along an outside edge of the base 70. The base also has a hook 68 along each side edge, which defines a cantilever snap 69, which is received in a corresponding recess formed in a pocket defined between a corresponding keycap hook 66 and part of the interior sidewall surface adjacent the hook.

The body 64 has a plunger 72 that extends outwardly and downwardly from the base 70. The plunger 72 is received in a socket in a key switch (not shown) that is equipped with one or more electrical contacts that close when the keycap 50 of a display key 44 is pressed. Although not shown, the plunger 72 can be carried by or otherwise be part of the key switch that extends outwardly from the key switch and cooperates with the body of the key. Such a plunger 72 is received in a receptacle or socket carried by or otherwise formed of part of the body.

The key switch is anchored to part of the keyboard, such as part of the keyboard frame. In one preferred embodiment, the key switch is attached to a circuit board, such as a PCB board or the like, which is in turn can be carried by a frame or housing of the keyboard.

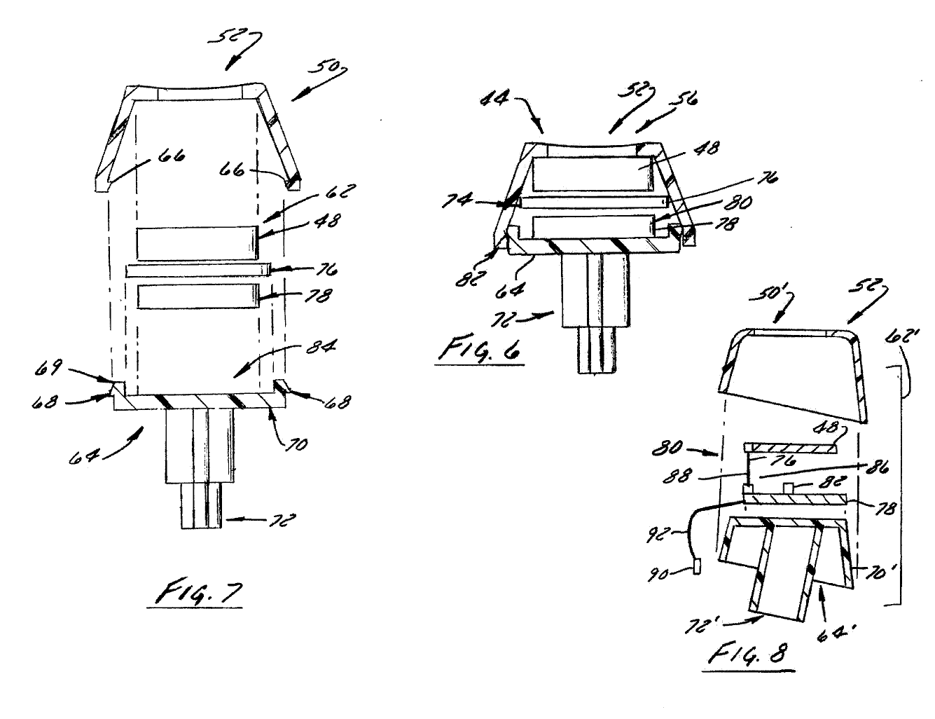

The key display assembly 62 includes the display 48, which is disposed adjacent the window 52 in the top surface 56 of the keycap 50 in the manner depicted in FIGS. 6 and 7. A spacer 74 is located between the display 48 and another component that is disposed adjacent it and the base 70 of the body 64. Where the display 48 is of non-emissive construction, such as where the display is an LCD, the spacer 74 can also be or serve as a diffuser 76 that helps diffuse light from a backlight 82 (FIG. 8). The backlight preferably is carried by or forms the component disposed adjacent the base of the body. This component is a circuit board 78, such as a PCB board or the like, that can include driver circuitry 80. The circuit board 78 is shown in FIG. 7 as being received in a key display assembly seat 84 that is located between cantilever snaps 82 of the display key assembly base 64.

Such driver circuitry 80 can include an onboard processor, such as a microprocessor or microcontroller, along with onboard memory capable of holding display image data to control which dot or pixel is activated, not activated, as well as to what level of intensity and/or color depending on whether the display is of black-and-white, grayscale/monochrome, or color construction. Where also equipped with a backlight 82 (FIG. 8), the backlight 82 can be an LED or another type of light.

Display image data memory, such as onboard display image data memory, can be sized and configured to hold a plurality of display image data, e.g. display image data for at least two images, or even a plurality of pairs of display image data, e.g. display image data for at least three images, such as where it is desired to be able to quickly switch between two or more images. For example, where a key display is employed to animate an image it is showing or is to form part of a larger image that is also animated, being able to store display image data for multiple images onboard the display key 44 can help make such animating faster and smoother. For example, image data for as many as four or more images are stored and can be retrieved during animation in a manner that sequences it much like animating an animated GIF or the like is done. Depending on the control circuitry, hardware, software, firmware, etc., it allows for animation of a single image on a single display key 44, a plurality of display keys 44, or all of the display keys 44.

FIG. 8 illustrates another preferred display key embodiment. The keycap 50′ overlies and is assembled to the body 64′ in a manner such that the two components are not easily disassembled. In one preferred embodiment, the keycap 50′ and body 64′ snap together, such as in a manner like that depicted in FIGS. 6 and 7.

The key display assembly 62′ is held captive between the keycap 50′ and the base 70′ of the body 64′, between the underside of the frame of the top surface of the keycap and the base of the body. Disposed underneath the display 48 is a driver circuit board 78 that is equipped with driver circuitry 80 used in driving the display 48 to cause it to show the desired image(s) and/or image series. Such driver circuitry is configured to receive control digital signals and power from the keyboard 40 and/or the device to which the keyboard 40 is connected and act upon them. For example, such driver circuitry can be configured to drive the appropriate dot/dots or pixel/pixels in accordance with received control signals. Such driver circuitry 80 preferably includes an LCD driver chip that can be of static drive or multiplexed drive construction and that preferably are capable of accepting CMOS and/or TTL control signal inputs.

Where the display 48 is an LCD, the circuit board 78 can be and typically is equipped with LED backlighting, such as in the form of at least one LED 82 mounted to the circuit board, such as depicted in FIG. 8. Where backlighting is employed, a diffuser 76 can be and preferably is located between the backlighting 82 and the display 48. For example, a diffuser 76 is located between the circuit board mounted LED 82 and the backside of the LCD display 48 in the preferred embodiment of the display assembly shown in FIG. 8.

A connector arrangement 86, such as a Zebra connector, is used to connect the display 48 to the driver circuit board 78 by a cable 88. Another connector 90, which is also connected to a cable 92, is used to link the driver circuit board 78 to another circuit board (FIG. 11) of the display keyboard 40 and/or a bus that is in communication with the device to which the display keyboard 40 is connected or linked. Where cables 88, 92 are used, they can be ribbon cables or the like.

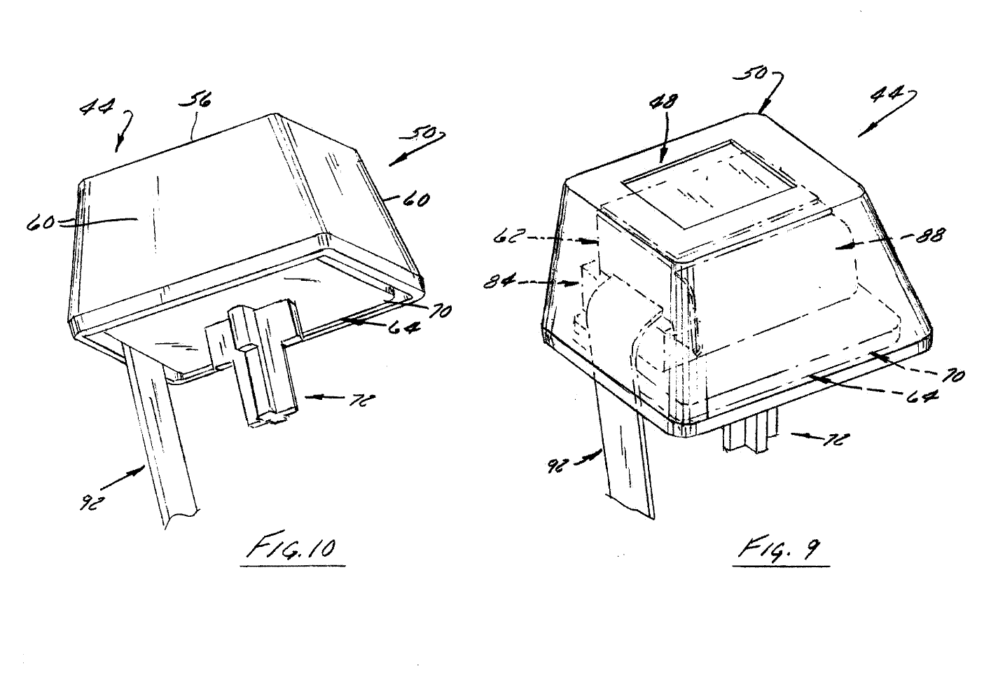

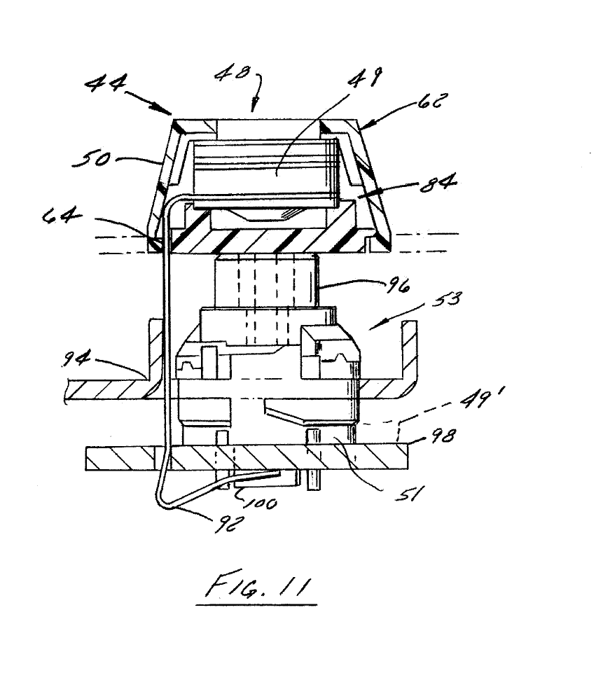

FIG. 9 illustrates a preferred embodiment of a display assembly captive within a display keycap 50 assembled to a key body 64. A cable 88 that communicates control signals to the display 48 is shown as being threaded through a channel formed in either or both of the display keycap 50 and/or body 64. In a preferred embodiment, communication between the driver circuit board 78 is bi-directional such as to enable an action to be taken or option presented upon or after one or more particular display keys 44 display a particular desired image and/or series of images.

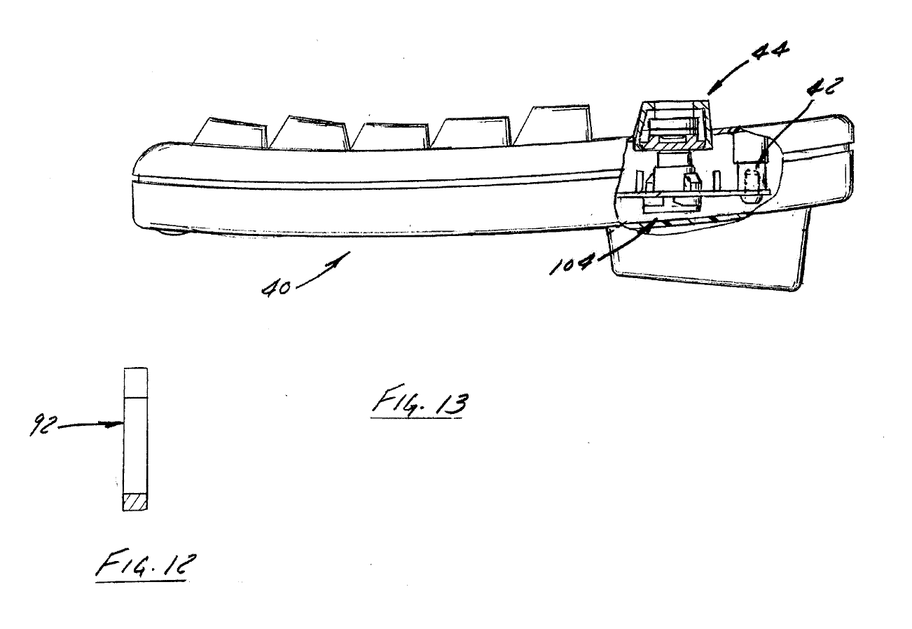

FIG. 10 illustrates the display key 44 of FIG. 9 without any transparency of the keycap 50. The control signal cable 92 extends outwardly from a channel formed between the display keycap 50 and body 64, the keycap 50 or in the body 64. Referring additionally to FIG. 11, the control signal cable 92 is threaded though space between a frame 94 of the keyboard and the key switch 96 of the display key 44 and connected to a circuit board 98 of the keyboard, such as by a Molex connector 100, a Molex-type connector or another suitable connector.

In another preferred embodiment that is not shown in the drawings, the free end of the cable has a connector that plugs into a complementary electrical socket that is carried by the display keyboard and disposed within easy reach of anyone attaching a display key to the keyboard. In one preferred embodiment, the electrical socket is mounted to a circuit board of the keyboard, is positioned adjacent the key switch of the display key and a frame of the keyboard, and extends outwardly therefrom such that it can easily be plugged or unplugged by a person removing or attaching a display key. Such a plug-and-socket arrangement advantageously permits a display key to be removed from and unplugged from a display keyboard, such as when display key replacement is desired or required. Such a plug-and-socket arrangement also permits a keyboard to have on or more non-display key locations that are display key capable or display key enabled.

In another preferred embodiment, control signal wiring extends to the body to a coupling integral with a plunger-receptacle arrangement. In one preferred embodiment, where the display key is equipped with a plunger, control signal wiring extends to a plurality of contacts carried by the plunger. Complementary contacts are disposed within the plunger-receiving receptacle of the key switch and make continuous contact with corresponding plunger contacts while the display key is stationary, when it is being pressed, and when it has been released. Such contacts can be molded in place or can be fixed in place, such as by use of an adhesive, heat or the like. A converse contact arrangement is employed where the display key body is equipped with the plunger-receiving receptacle and the key switch is equipped with the plunger.

In a still another preferred embodiment, control signals are communicated via spaced apart conductors, e.g. wires, disposed in, e.g., embedded, in the plunger with one or both axial ends of the plunger being equipped with a connector and/or contacts that are in electrical contact with a complementary connector and/or contacts. Such a connector and/or contacts remain in continuous electrical contact such that control signals can be conveyed at any time during operation to and/or from the display and/or display driver circuit board. A spring or other type of biasing element is employed at or adjacent one or both ends of the plunger to maintain electrical contact with the plunger connector(s) and/or contacts at one or both ends of the plunger even during plunger movement due to key press and key release.

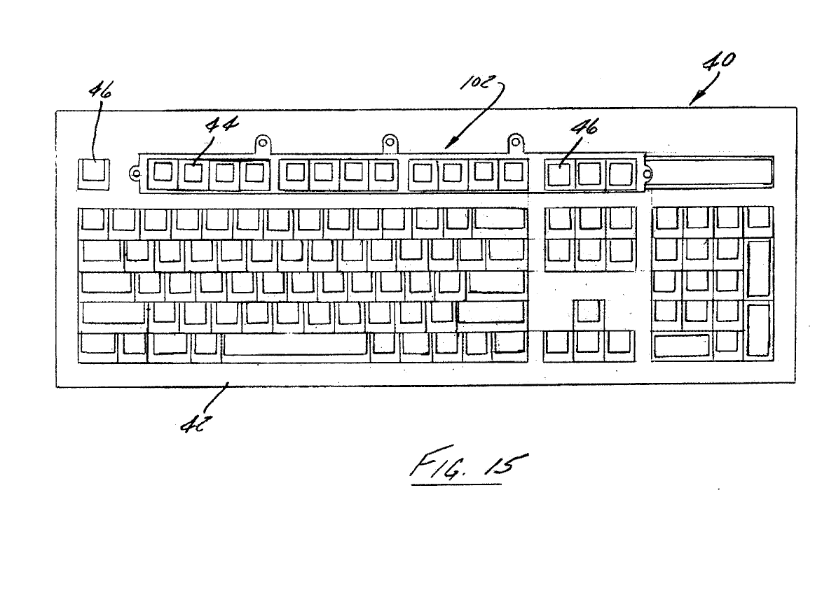

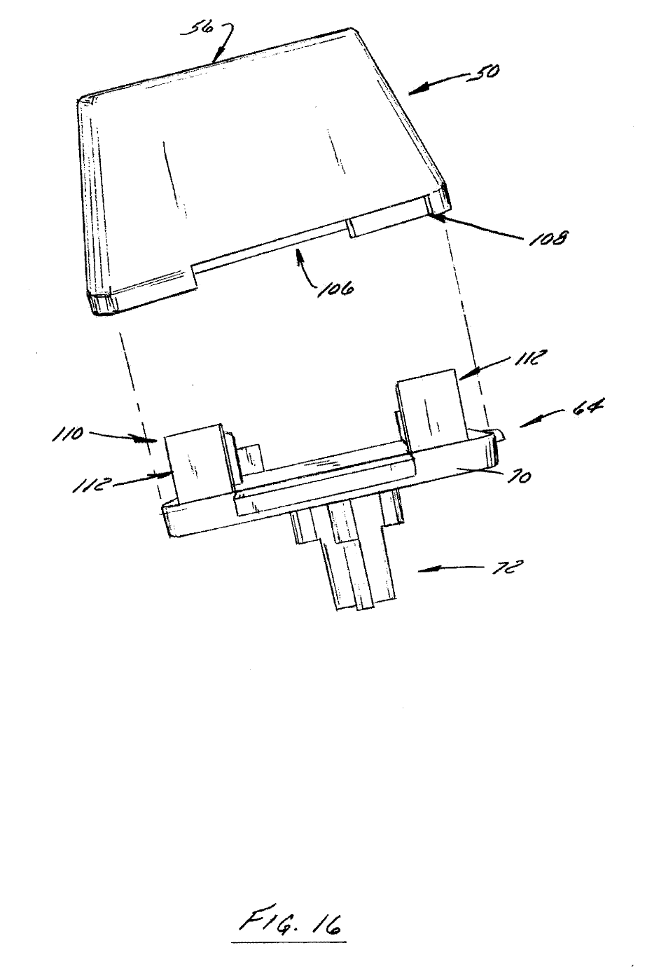

FIG. 15 illustrates a preferred embodiment of a display keyboard 40 equipped with a set of function display keys 102. FIG. 13 illustrates a side view of the keyboard 40 with a portion of its housing broken away to depict a display key 44 and key switch assembly 96. The display key 44 constructed in accordance with the invention can be the same as or similar to the display key shown in FIG. 4 and employs a display key assembly 104 in accordance with that depicted in FIGS. 5-7, FIG. 8, FIG. 9, and/or FIGS. 11 and 14.

FIGS. 16-30 illustrate various views of a preferred display keycap 50 and body 64 of snap-together construction that snaps together around a display assembly 62, such as is depicted in FIGS. 6 and 7, FIG. 8, FIG. 9, and/or FIGS. 11 and 14 and/or in accordance with that discussed above. The base 70 of the body 64 has hooks 68 that extend outwardly along each one of its side edges that are each received in a corresponding recess 106 formed in the display keycap 50. The keycap 50 can also include a channel 108 formed along one side that provides a guide for any required cabling, including control signal cabling 92 (not shown in FIG. 16). The base 70 of the display key body 64 includes an integrally formed cradle 110 that is constructed and arranged to receive and help support at least a portion of a key display assembly 62 (not shown in FIG. 16). For example, in a presently preferred embodiment, a display driver circuit board 78 (not shown in FIG. 16) seats in the cradle 110. As is shown in FIG. 16, the cradle 110 is formed by part of the key body base 70 and a pair of outwardly extending seat supports 112.

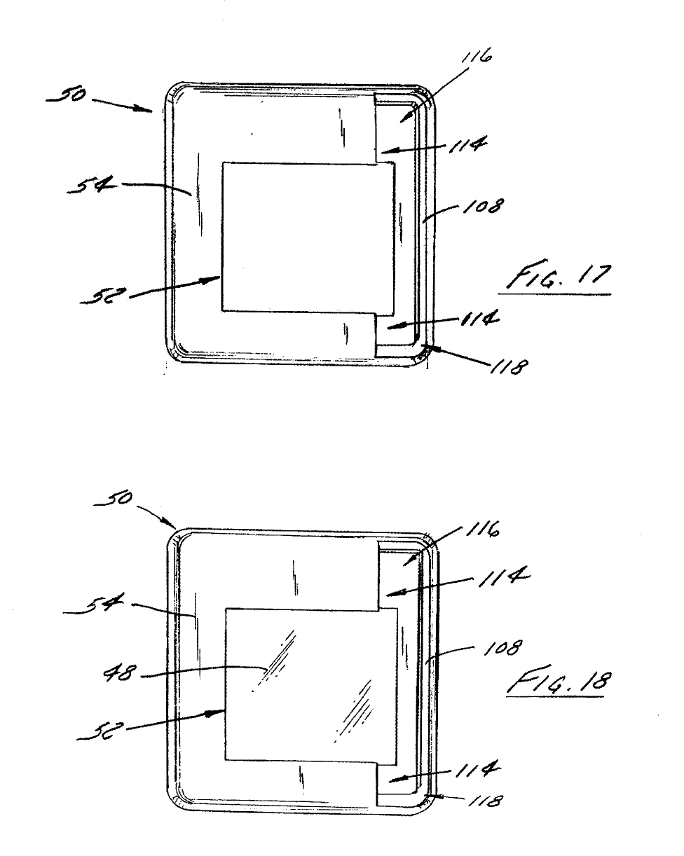

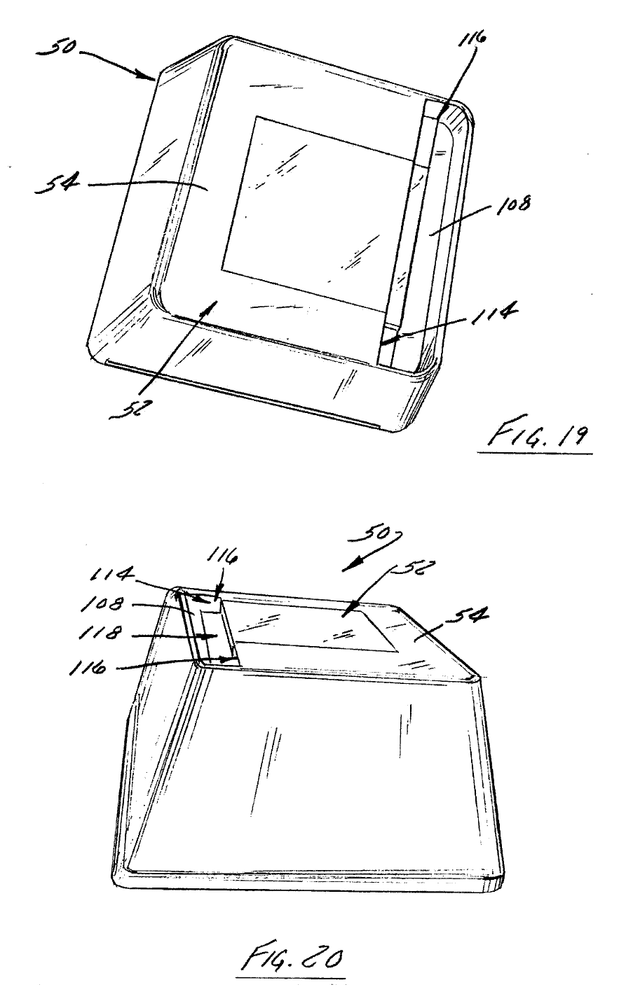

FIGS. 17 and 18 show a top view of the top surface of the keycap 50, which can be concave, particularly when used in PC display keyboard applications. FIG. 17 illustrates the display keycap 50 with the display removed and FIG. 18 shows the display 48. The top surface of the keycap is cut away to depict a cabling guide channel 108 that can be used for a connector between the display 48 and any display driver circuitry not disposed on board the display 48 as well as for cabling, including cabling associated with such a connector. In addition, such a channel 108 provides a conduit for any control signaling cabling, power cabling, and the like.

In another preferred embodiment, the cut away portion facilitates assembly and/or seating of the display 48 in the display keycap 50. After assembly and/or seating of the display, a retainer (not shown), which can be made of the same material as the keycap, is assembled to the keycap 50 by placing it in the cut away portion to prevent relative movement of the display 48 and keycap 50 as well as prevent removal of the display 48 from the keycap 50. The retainer is a generally piece of material that can be generally rectangular in shape that engages with the display keycap 50 so as to be difficult to remove after assembly. A snap-fit, friction fit, or another type of engagement can be provided between the retainer and keycap 50 to keep the retainer assembled to the keycap 50.

In assembly, the display panel 48 is inserted into a channel 114 in the keycap top that is generally parallel to at least a portion of the keycap top surface and/or one pair of opposed sides of the top surface border 54 defining the display window 52. After the display panel has been inserted into the channel in the keycap top wall, any connector, plug or the like is attached to a corresponding complementary connector, plug, interface, or the like disposed along a side edge of the display panel that is exposed through the cut away. After attachment of any connector, plug, interface, cabling, etc. is completed, the retainer is attached to the keycap by inserting it into the cut away 116 in the top of the keycap through display insertion mouth 118.

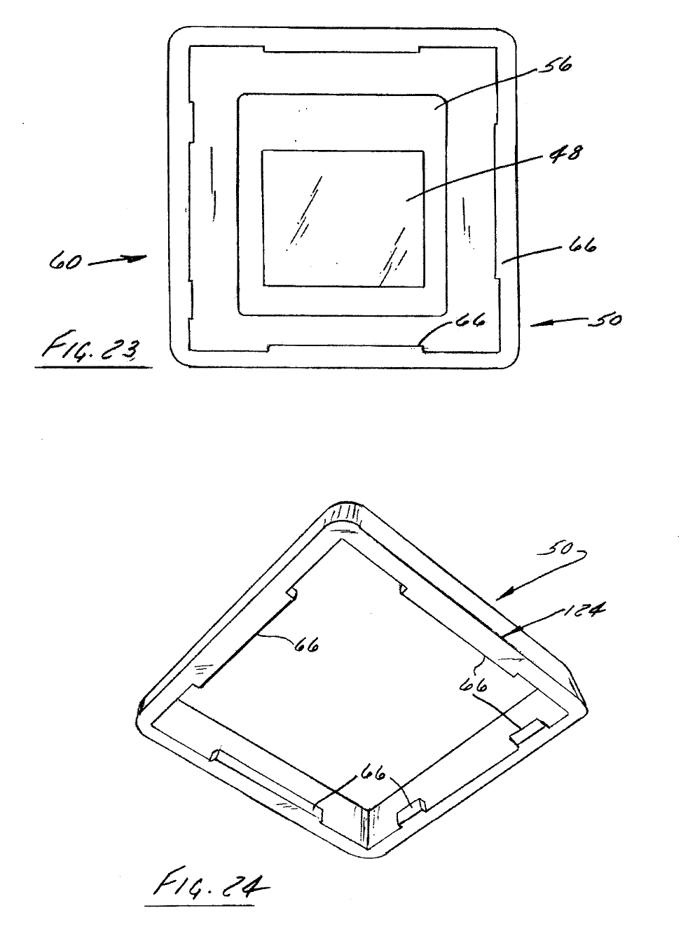

FIGS. 21-24 illustrate one preferred embodiment of a guide channel 120 integrally formed in a sidewall 60 of the display keycap 50. The guide channel 120 extends from an interface or connector edge 122 of the display 48. FIG. 24 depicts a cabling outlet port 124 formed in a keycap sidewall. FIGS. 22-24 illustrates hooks 66 that project from an interior surface of each keycap sidewall that snap into corresponding recesses formed in the base 70 of the display key body 64. In another preferred embodiment, the hooks 66 ride over corresponding hooks 68 of the base 70 of the display key body 64 thereby creating an interference therebetween once assembly is completed that prevents the body 64 and keycap 50 from being disassembled.

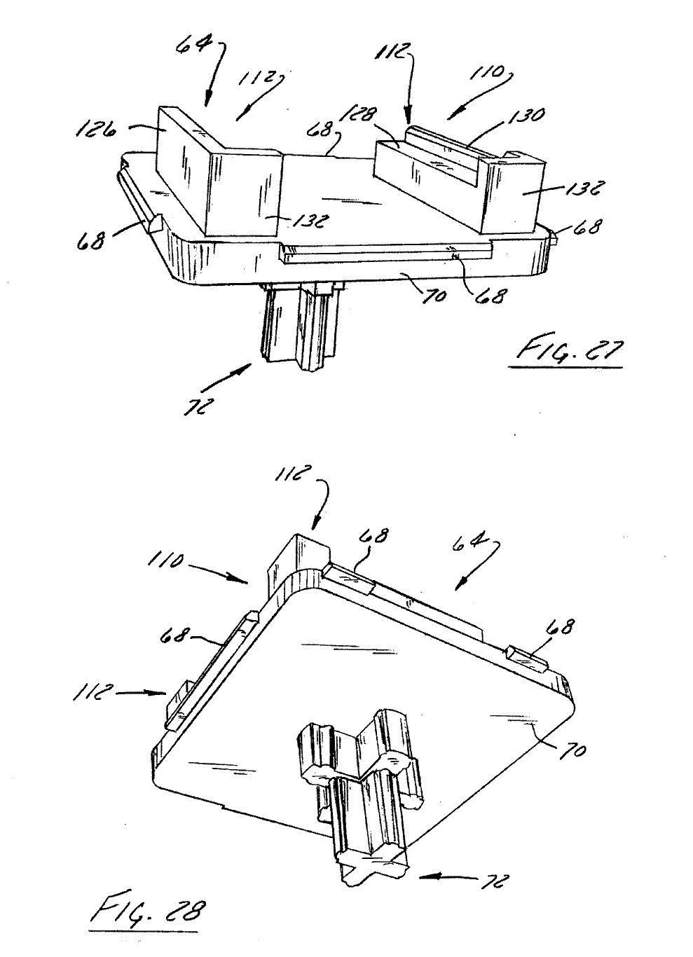

FIGS. 25-27 illustrate a preferred embodiment of a display assembly receiving cradle 110. The cradle 110 has a plurality of upright and elongate L-shaped pedestals or supports 112, each of which has a longitudinally extending edge 126 that is upraised from a land 128 upon which part of the display assembly 62 (not shown in FIGS. 25-27) can rest. One edge has at least a portion that is beveled 130 to provide clearance, such as for enabling cabling or the like to be routed over the beveled edge 130. There also is an upraised backstop 132 at one longitudinally extending end of each land 128 that is generally transverse to a respective upraised longitudinally extending edge 126.

Both the keycap 50 and the body 64 are molded of plastic, such as by plastic injection molding or another suitable plastic molding method. The keycap 50 can be molded of an opaque material with the display window 52 and any display receiving slots or channels integrally formed during molding. The display key body 64 includes a plunger 72 that can include conductors, contacts, and/or wiring in accordance with that discussed above. When the display key 44 is depressed, the plunger 72 moves in unison with the key into its key switch 96 until the switch (not shown) of the key switch 96 makes electrical contact. Upon release, a biasing element, such as a spring or the like, urges the display key 44 outwardly to its normal home position readying it once more to be pressed.

With reference to FIG. 11, one or more of the display-equipped keys 44 can be equipped with a transducer 49 that can emit sound and/or vibrate, such as for providing and/or enhancing tactile feel of the key 44. For example, such a transducer can increase its output intensity and/or frequency in response to a given condition occurring, which can be tied to the display of a particular image, one image of a particular image series, the position of a key, including a display key, etc. In one preferred implementation, the transducer 49 within the display key 44 is energized to provide tactile feel feedback, such as by increasing its output intensity as the display key 44 equipped with the transducer is depressed and reducing its output intensity as the display key 44 equipped with the transducer is released or otherwise allowed to return to its un-depressed or home position. In another preferred implementation, transducer feedback can be provided when a display key 44 equipped with a transducer is wrongly depressed so the user knows to release the key. For example, in one preferred implementation where a condition changes during the pressing of a display key 44 equipped with a transducer such that the key 44 should be released, tactile feedback provided during key-press signals the user to release the key. This can advantageously enable the user to make a different, more correct choice of key to press or can enable the user to make an entirely different input choice. Examples of such a different input choice include making a selection with a mouse, inputting an audible command through a voice recognition interface, or by the use of another type of input.

Such a transducer 49 can be of piezoelectric construction, point-source construction, or of another arrangement that is capable of being made small enough for inclusion in a keyboard, particularly within a key 44 of a keyboard. In a preferred embodiment, the transducer 49 can be mounted to the display key circuit board 78 between the keycap 50 and the body 64. In another preferred embodiment, a transducer 49′ (shown in phantom in FIG. 11) can be mounted to circuit board 98 of the keyboard adjacent a base 51 of a keyswitch 53 of the key 44.

In another preferred embodiment, the transducer 49 is used on a key that lacks any display. The same or similar snap-together key cap and key body construction is employed with control signals, e.g. sound signals, and power being communicated via cabling and/or the key plunger to the transducer.

A display PC keyboard is an example of a display data entry unit constructed in accordance with the invention having a row of depressible function keys 44 (FIG. 2) along the top of the keyboard, at least a plurality of pairs of which are equipped with displays. Each display key 44 is depressible as each can be pressed downwardly a distance so as to cause a signal to be generated that indicates the key has been pressed that is ultimately communicated to a processor-equipped device, such as a computer (not shown), linked to the keyboard. For example, in a preferred embodiment, the device is a computer, such as a desktop, notebook or server computer. However, as previously indicated above, the display keys can be part of an input device linked to another device, such as a device capable of at least being partially controlled by the display key equipped input device. In a preferred display keyboard embodiment, function keys normally corresponding to F1-F12 are each display keys each of whose display is configurable such as in the manner disclosed above. Each display key can display a different image or icon during use and operation although two or more keys having the same image or icon is within the contemplated scope of the invention.

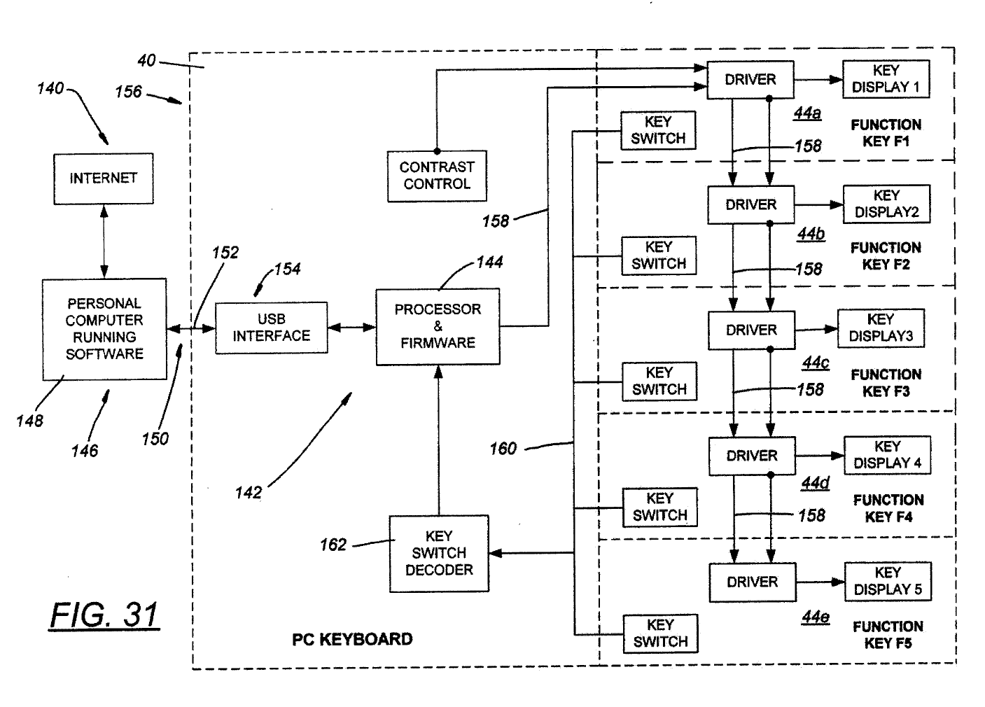

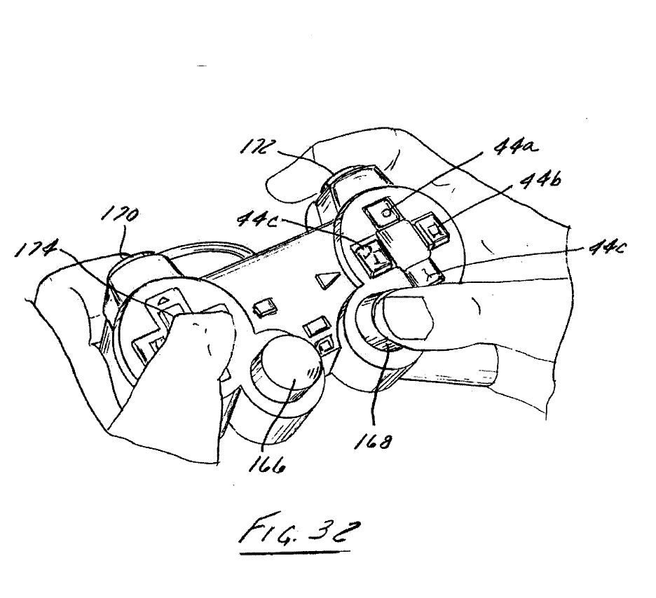

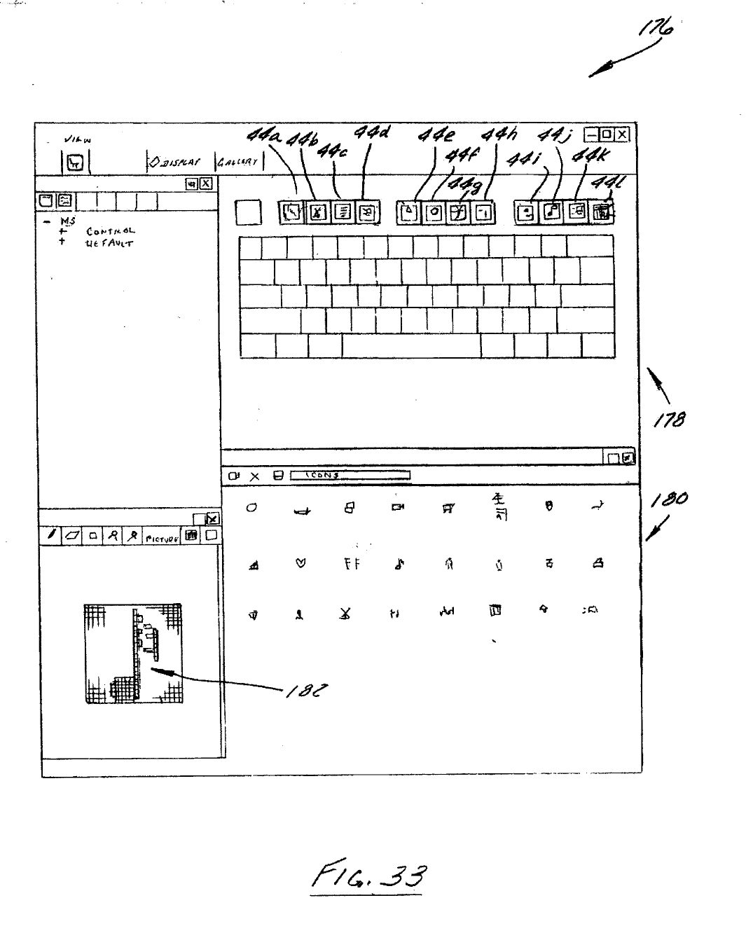

FIG. 31 depicts a system, arrangement and interface of a display keyboard 40 used in conjunction with a processor-controlled device, which in this case, is a personal computer 146. A processor 144 that can be located onboard the display keyboard 40 communicates with a display driver arrangement, such as like that depicted in one or more of FIG. 6-9, 11, or 14 that is located onboard a display key 44 to control display key operation. For example, in a preferred embodiment, the onboard display key controller processor 144 depicted in FIG. 31 is linked to an onboard key display driver that in turn is linked to the display located onboard that same display key. The processor delivers or coordinates delivery of image display data to the driver which in turn applies electrical power to the display as needed to cause the display to produce the image corresponding to the image data.

The display driver includes driver circuitry and/or components that interface with the display onboard the display key in a manner that controls display operation in accordance with signals and/or data received, such as from the display key controller processor. Display key controller processor operation is controlled at least in part by firmware that typically also is disposed onboard the display keyboard. While firmware is preferred, software can be employed instead of or in addition to firmware. In a preferred processor embodiment, the firmware is stored onboard the processor such as in memory located thereon. For example, in one preferred embodiment, the firmware is stored in EEPROM onboard the processor.

FIG. 31 schematically depicts an embodiment of a system 140 for a display data entry unit 156 that includes a controller arrangement 142 that can be implemented in software or firmware by processor 144 by which sets of image data for a plurality of pairs of display function keys 44a, 44b, 44c, 44d and 44e are communicated from a processing device 146, e.g., computer 148, via a bus 150 that is a USB bus 152 and interface 154 to the processor 144 of the display data entry unit 156, e.g., display keyboard 40. The sets of key display image data for a plurality of display keys 44a-44e is delivered from the processing device 146 using the USB link 152 and interface 154 to the processor 144. The sequence or order of the sets of key display image data determines which one of the display keys 44a-44e receives which set of image data to control which display key displays which image. It can be predetermined with set order received by the processor 144 determining which set of image data will provided to which particular display key 44a-44f.

If desired, additional data can be provided, such as via the processing device 146, which the processor 144 can use to assign each received set of image data to a specific display key 44a-44f. If so, the processor 144 can be configured, such as via firmware or the like, to slot, order or reorder the received sets of image data so image data sets will be serially delivered in the desired order to the display keys 44a-44f when the processor 144 communicates the image date via the serial bus to the display keys 44a-4e.

In one method of operation, a plurality of sets of image data, I₁-I₅, is delivered to the processor 144. The processor 144, once ready to change the images being displayed on display keys 44a-44e, communicates the image data via a serial bus 158 such that set I₅ is slotted first to be delivered on the serial bus 158, I₄ is slotted next, I₃ is slotted after I₄ and so forth. Once the bus 158 is full such that a set of image data for each one of the display keys 44a-44f has been communicated serially on the bus 158 to the display keys, each display key 44a-44f receives the desired image data and thereafter displays the desired image associated with that image data. For example, a first image associated with first in queue image data set I₅ will be delivered first to bus 158 so it is received and displayed by display key 44e, a second image associated with second in queue image data set I₄ will be delivered second to bus 158 so it is received and displayed by display key 44d, a third image associated with first in queue image data set I₃ will be delivered third to bus 158 so it is received and displayed by display key 44c, a fourth image associated with first in queue image data set I₂ will be delivered fourth to bus 158 so it is received and displayed by display key 44b, and a fifth image associated with first in queue image data set I₁ will be delivered last to bus 158 so it is received and displayed by display key 44a.

In a further preferred method of display key use and operation, a display key 44a, 44b, 44c or 44d is pressed; it closes its associated keyswitch causing a signal to be communicated along a bus 160 to a key switch decoder 162 that can be of conventional construction and configuration. More specifically, a display keyboard constructed in accordance with the invention is contemplated to use a conventional keyboard keyswitch decoder and associated circuitry. The key code associated with the particular display key 44a, 44b, 44c, 44d or 44e that was pressed is communicated via bus 150 ultimately to the processing device 146. In the preferred embodiment shown in FIG. 31, the key code, e.g. ASCII code, corresponding to the pressed display key 44a, 44b, 44c, 44d or 44e is communicated to the processor, which in turn, communicates it to the processing device. The processing device 146 thereafter interprets the received key code and executes the task or function associated with the code. Where the display data input device 40 is also equipped with non-display keys, the same key switch decoder arrangement is advantageously employed such that only a single key switch decoder 162 handles key switch signals received from display keys and non-display keys.

A display keyboard constructed in accordance with the present invention has a plurality of pairs, e.g., three or more, of display keys. Each display key has an onboard display driver linked to one other display which is linked to at least one other display driver of another display key. Each driver is daisy chained or serially linked such that all of the drivers are linked serially such as forming a serial bus. This serial linking of drivers advantageously facilitates display image data delivery in a fast, economical and efficient manner. It is fast because it is of low-latency construction. It is economical because fewer components are needed. It is efficient because display image data for two or more keys can be represented using a minimum number of bytes and header information (if needed).

As previously discussed, each display key also includes a keyswitch that is constructed and arranged to cause a signal to be generated when the key is displaced, such as by a sufficient minimum displacement amount, such as when pressed by a user. Each keyswitch of each display key is linked to a keyswitch decoder by a common bus. The keyswitch decoder can be processor equipped where needed and can be liked to the key display controller processor if desired. If desired, the keyswitch decoder can be separate from the display controller processor, such as where the keyboard includes both display and non-display keys.

USB interface hardware is provided, preferably onboard the display keyboard, e.g., on a circuit board inside the display keyboard housing, but can be located off-board if desired. Data and/or signals, including key display image data, feedback related to the display thereof as well as keyswitch/key press data are communicated in the desired manner between the devices to which the display keyboard is linked. For example, as shown in FIG. 31, such data and/or signals are communicated between a host computer in a desired manner. Such data and/signals interact with, are processed by, or otherwise influence or are influenced by a software application of or in communication with the host PC.

For example, such a software application can be a computer program, such as an application program (e.g., word processor, presentation software, spreadsheet, etc.), a game, or some other type of software run or otherwise executed by the host PC. In one preferred embodiment, the software is network based or network communicated, such as a network-based software application (e.g., a back office application such as Microsoft Exchange or the like), which includes Internet based or Internet communicated software. Thus, such software of the host PC preferably is configured or configurable in some manner to affect the appearance, quantity, associated conditional logic, etc. of key display image data that is displayable on at least one display key and preferably at least a plurality of display keys. While the software can be configured or configurable to do such directly, an intermediate software layer, such as a software layer or module between it and the operating system of the host PC can be configured and employed to do such.

In operation, key display image data for a display of display keys is delivered serially to each of the display keys with the display image data for the display key located most downstream being first and the display image data for the closest most upstream located display, i.e. key 1 in FIG. 31, being last in the stream of display image data delivered. If desired, each key display image can be represented by a set of data having a link, e.g. software pointer, that enables key display image data for a plurality of display keys to be reordered, selectively removed and replaced, selectively deleted, replaced, etc. for one display key at a time, a plurality of display keys at a time, a plurality of pairs of display keys, etc.

In one preferred implementation, a linked list of key display image data sets is serially strobed to all of the display keys of the display keyboard. The linked list can be assembled at the host PC and delivered to the display keyboard such that it is delivered pre-ordered enabling the display controller processor to simply hand the display image data off to the drivers of the display keys. In another preferred implementation, a plurality of display image data sets are delivered to an onboard display key controller processor, which then puts it in order before delivering it to the display keys.

With reference to FIG. 31, in one preferred embodiment, the key display controller is a microcontroller with onboard firmware storage used for communicating with the host device, e.g., host PC, for effecting storage of display image data for at least the graphics or icons being displayed on the key displays of the display keyboard, refresh the displays as needed, and preferably also convert key press data into scan codes communicated to the host device, e.g., host PC, over its linking interface. In the preferred display PC keyboard depicted in FIG. 31, the host device linking interface is a USB interface.

Key display image data is fetched from memory, preferably located onboard the display keyboard, and communicated by the key display controller along the serial key display data bus to each one of the display keys. Such a bus advantageously is not just economical in construction and implementation; it is also expandable as it is capable of delivering key display image data to at least 100 key displays without any additional hardware. In a preferred embodiment, such a novel bus configuration is expandable such that it can serve as a conduit and deliver key display image data to display key equipped input devices having anywhere between a plurality of display keys to as many as 125 display keys, thereby making it particularly well suited for use in a wide variety of display keyboard and display keypad applications. Moreover, not only is the bus configuration particularly advantageous for expandability, it is also versatile and flexible by being usable with just about any kind of display key equipped input arrangement, including those involving non-display key equipped input devices adapted by equipping them with two or more display keys.

In a preferred embodiment, a bus constructed in accordance with that disclosed in FIG. 31 advantageously distributes key display image data for each display key desired to be “lit up” in a sequential line of display image data records with one record following another and their order corresponding the order which the key displays are sequentially linked, e.g., daisy chained together. The key display controller preferably has enough onboard memory, such as RAM memory, to store at least one set of key display image data containing key display image data for each display key of the display keyboard or keypad. As a result, the displays need not be connected via any decoder matrix arrangement, such as is done with the key switches as discussed below in more detail.

The key switches of the keys, including preferably all display keys and non-display keys, are connected via a matrix decoder thereby reducing the number of processor input/output (I/O) lines required. The less number of keys, the smaller the matrix and corresponding decoder required, as well as the smaller the processor, e.g., microcontroller, can be used. Where the keyswitch circuitry, including any decoder, e.g. matrix decoder, used is separate from the key display controller and associated circuitry, conventional key switch decoder circuitry can be used that employs a processor, e.g. microprocessor or microcontroller, that is separate from the processor of the key display controller hardware.

In one preferred embodiment, such key display circuitry, firmware and the like preferably is configured or configurable to permit bi-directional data transfer (digital data) of at least display key related data, including key display image data, to and from the display keyboard, namely the key display controller processor. The same can also be true for key press data and related hardware, firmware and the like.

The linked key display image data record architecture preferably enables key display image data for just a single display key to be delivered to the key display controller processor where its tag, ID, reference, or even its order, including designated order, enables it to be inserted in the linked list of key display image data records stored in onboard memory. In one preferred implementation, it replaces the prior key display image data record for the display corresponding to that particular tag, ID or reference such that the next time the key display controller processor delivers display image data to the display keys, the new key display image will be shown on the key display associated with the particular tag, ID or reference. Where a set or list, e.g., linked sequential list or ordered sequential list, has already been delivered to the display keys, the new key display image data is inserted where appropriate and delivered when the key displays are next refreshed, such as preferably during a subsequent clock or timing signal.

In one preferred implementation, each key display is assigned a corresponding memory location of the onboard key display memory. Key display image data sent from the host device to the display keyboard for showing on a particular key display is designated for memory storage in the onboard key display image data memory corresponding to that display key. When requested to fetch the key display image data from memory and display it, preferably from a signal provided by the host device, e.g., preferably generated by software it is running, the key display image data is retrieved and sent to the daisy-chained key displays, which then display the image defined by the key display image data received. Key display data is arranged in memory in order corresponding to that of the daisy chained key displays.

In like manner, key display image data for one, two, and three, all the way up to all of the display keys can be delivered from the host device, e.g., host PC, to the display keyboard for onboard memory storage in this manner. Image change preferably is fast, preferably occurring in as little as a couple of clock cycles per set of key display image data sent to the display keyboard. Actual delivery to the desired display keys is similarly fast, with latency remaining sufficiently low that animation of key display images singly or as a group can be carried out in a realistic manner.

In another preferred embodiment, the key display image data is either stored onboard the host and/or delivered directly to the key display controller, which in turn delivers it to the desired key displays sequentially in a manner in accordance with that previously discussed above. Where latency is low, such as where USB 2.0 or higher is used, key display image data delivery from the host device may be desired, even advantageous in certain instances. In such instances, order, image arrangement, etc. of the key display image data can be solely determined by software and/or firmware of the host device, if desired.

In another preferred embodiment, the arrangement disclosed in commonly owned U.S. Pat. No. 6,798,359, the entirety of which is hereby expressly incorporated herein and is used to deliver key display image data to at least a plurality of display keys and cause the desired key display image data to be displayed on a corresponding one of the display keys.

With reference to FIG. 32, during game playing using a hand-held controller 164 equipped with at least a plurality of pairs of display equipped keys 44, interaction with anyone of the plurality of pairs of types of inputs, such as joysticks 166 and/or 168, buttons 170 and/or 172, control 174, or other display keys 44, onboard the controller 164 causes firmware or software running on the host device to which the controller is connected to in turn cause a corresponding image to be change and be shown on at least one of a plurality of pairs of display keys 44 onboard the controller 164. If desired, such software that interprets such input interaction can also be operational on the host device, such as the game computer or personal computer to which the controller 164 is connected. For example, depending on what function is invoked, direction taken, tool or weapon selected, level traversed, interaction with another game player, injury, type of input manipulated, e.g. joystick movement, key press, etc., one or more of the images shown on a corresponding number of display keys 44 correspondingly changes. In such a manner, these game controller display function keys custom tailor them via game and controller input interaction. This method and arrangement can be employed with other types of controllers including a paddle-type controller, a trackball equipped controller, a steering wheel equipped controller and the like.

In another preferred implementation of an operating method of the invention, the game player can select, designate or even create images that are always displayed on one or more of the display keys. Indeed, key display image sets can be designated, designed, selected, or even created by a game player that the game player can selectively cause to display and change as needed in response to the game player selecting a particular set, pre-conditioning displaying the images of a particular set upon occurrence of a particular event, function, condition, or occurrence thereby enabling a game player to custom design and control one or more of the display keys of the game controller.

While a game controller is shown in FIG. 32 for purposes of disclosing these aspects, benefits and features of the present invention, any and/or all of the aforementioned can be implemented on a game console equipped with one or more of such display keys. Preferably both the game controller and game console so equipped have at least a plurality of display keys. In a preferred embodiment, each is equipped with a plurality of pairs of display keys which can be controlled, operated, configured, etc. in accordance with one or more, even all, of the aforementioned discussed above with regard to the game controller of FIG. 32. In addition, these methods of operation, configuration, use, implementation and the like are not limited to display key equipped game consoles, game controllers, and other gaming input devices, such can also be used on display key equipped keyboards, keypads, tools, industrial equipment, automobiles, medical equipment, laboratory equipment, test equipment and the like.

As previously discussed, one of the primary aspects of a display key of the present invention has led to a new category of user input device, namely a user programmable display key and user input device so equipped (preferably with a plurality of such keys). Using a combination of hardware (miniature LCD panels or displays that fit inside electronic device keys and related keyswitch and PCB arrangements), and software (firmware and a client GUI that allows the user or third parties the ability to create and customize display images), display key technology in accordance with that disclosed herein provides a methodology for dynamic and infinitely changeable key identification.

There is a need for such display key equipped user input devices. For example, software is relatively complex such that user interface improvements are very desirable. The traditional “hierarchical” command structure of computing devices is slow and cumbersome. As a result, most users do not benefit from the full range of software features available, limiting the computing experience and general productivity. This is true regardless of device, from PCs to mobile phones, gaming consoles, gaming controllers, GAMEBOYS, to remote controls.

To try to address this problem, software developers offer “shortcuts.” Some shortcuts are obvious, like the ones you see on your toolbar right now. But most are “hidden,” meaning that users first need to discover them in documentation, learn them, and use them repeatedly to master their advantages. For example, even the most expert users can only remember so many shortcuts, maybe a couple dozen. In this regard, Microsoft Word has over 900 shortcuts which can be accessed via Tools->Macro->Macros->Macros in the command section of Microsoft Word.

Such a method implementation advantageously integrates such display key equipped devices into a system and method of operation that allows key displays to change dynamically from software application to software application. For example, where the software application is Microsoft Word, a display data entry unit API detects it is Word and causes a Word specific set of images to be displayed on the display keys 44 of the display keyboard 40 and causes a key press of any of these display keys 44 to execute a function or make a selection corresponding to the image displayed on the particular key 44 that was pressed. Load a game application and the same API detects which game has been loaded and causes a new set of key images automatically load of the display keys 44 of the display keyboard 40. In addition to loading display images on the display keys 44 that correspond to the software application that has been run by a user, the display data entry unit API cooperates with the software application to change images on one or more of the display keys 44 contextually, so display images can change as situations within software applications require.

In one preferred method implementation, cursor interaction with the software application causes images displayed on one or more display keys 44 to change along with the function the display key(s) 44 execute(s) corresponding to the new image displayed. For example, the display data entry unit API is configured to monitor focus as it pertains to the graphical user interface of the software application or device to which the display data entry unit is linked and changes one or more display key images and corresponding functions based on changes in program focus. In one preferred implementation, focus is monitored and image and corresponding functions are changed for one or more display keys 44 based on cursor location or a change in cursor location within a particular window of the software application with which the display data entry unit API interfaces. In another preferred method implementation, the API causes a change in one or more images and corresponding functions or selections of one or more display keys 44 where a menu item of the software application with which the API interfaces with is selected by a user, such as by using a mouse or the like. In still another preferred method implementation, display image(s) and corresponding function or selection of one or more display keys 44 is changed based on a user making a particular selection, such as via a control or escape key combination, a different type of selection made using a mouse or other input device, or by typing a particular keyboard sequence that lacks any control key, escape key or function key. While the aforementioned method is described for use with a display data entry unit that is a display keyboard 40, it is also well suited for use with a device, such as a computer or game console, that is linked to a game controller 164 the same as or like that shown in FIG. 32.

In method implementation, the software application is a browser, such as Internet Explorer or a Mozilla based browser such as Firefox. In one preferred method implementation, the display data entry unit API loads a particular set of images on the display keys 40 of the display keyboard 40 based on the website visited. If the website is display data entry unit compatible and the API detects the compatibility, the API will cause a set of images to be displayed on the display keys 44 of the keyboard 40 that correspond to the specific display data entry unit compatible website visited.

The API can scan the website cookie or cookies to determine what images to load, with one or more images and display key designations being stored in a cookie. In another implementation, the IP address of the website visited is compared against a lookup table, database or the like of IP addresses of display data entry unit compatible websites. Where a website is found in the table or database, the API loads the image data and display key designation data as to which image is to be displayed on which display key 44 from the table or database or from another table, database or file. Once loaded, the desired image data is transmitted to the display data entry unit where it is displayed as an image on the specific display key 44 designated by the designation data associated with the image data.

In another preferred implementation of a method in accordance with the present invention, a browser module or plug-in is provided that monitors the websites visited when a user is browsing websites using the browser. One preferred module is a Browser Helper Object (BHO) configured to detect whether a particular website is display data entry unit compatible and causes a corresponding set of images to be displayed on corresponding display keys 44 of a display data entry unit, e.g., display keyboard 40. Such a BHO can also consult a lookup table, database or the like based on the IP address of the current website in the browser window to determine whether the website is display data entry unit before fetching a corresponding display key image or set of images associated with the particular website if it is display data entry unit compatible.

One preferred type of plug-in is an ActiveX control that is configured to carry out the same method implementations as the BHO described above. Such an ActiveX control can be implemented for use with a browser or for use with a particular software application, such as Microsoft Word or the like.

The display key images, including function, context or location based sets of display key images can be developed by users themselves, by system administrators, and/or by software developers. In a preferred implementation of a method, there are three levels of display data entry unit operation customization. First, individual users can create their own icons and functions, using an image editing software application that runs on the host device to which the display key equipped user input device is connected.

Second, Internet sites, Internet-based companies, Internet applications, including plug-ins and the like, preferably deliver host device executable code that automatically provides and/or selects images that are delivered to and show on the displays of one or more of a plurality of display keys 44 of the display key equipped user input device 40. In one preferred implementation, code is embedded in a web page, preferably HTML or XML code, causing corresponding desired images to be displayed. Such images can communicate information related to an advertised special, another company in a cross-marketing venture with the website, allow a user to get help pressing a help image caused to be displayed on a display key 44, allow a user to obtain more information related to that which is shown on the web page by pressing on a corresponding display key 44 showing an image associated with that which is shown on the web page. Other website compatible code, such as HTML or XML code can be embedded by companies, website developers, website administrators, etc. in their web pages that will automatically launch images which nearly immediately are shown on corresponding display keys 44 of a display data entry unit 40.

Third, software developers can engineer any of these capabilities into their software application thereby causing desired images to be shown at certain desired times on one or more display keys 44. For example, software developers can program the ability to communicate with a display data entry unit API configured in accordance with that discussed above.

In one preferred implementation in accordance with the foregoing, software executable on a host device to which a display key equipped user input device is linked preferably includes an image editor, an image layout editor, and/or an API preferably for third party software developers.

Internet applications can be display key user input device configured or configurable by embedding the desired code, preferably HTML or XML code, in web pages and images in web server based image folder. When the host device browses a display key code enabled web page, the code, e.g., HTML or XML code, is executed either by the web server but more preferably by the host device, causing retrieval and downloading of one or more desired key display images from the server based image folder. In one preferred implementation, XML code is employed. One or more of such images are, in turn, delivered to the display keyboard or display keypad where the display controller processor causes each such image to be displayed on a desired display key.

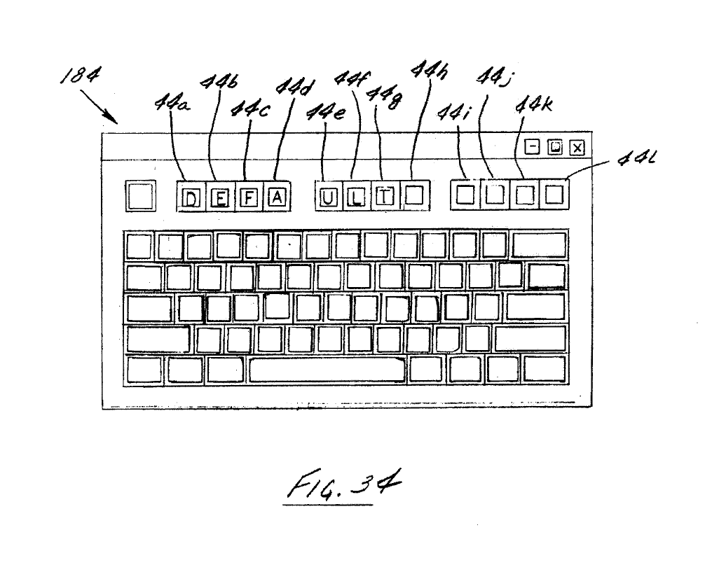

FIG. 33 illustrates a screen shot 176 of a preferred but exemplary implementation of a key display image layout editor, which is used to assign images or image data to a particular display key 44 of a display data entry unit 40. Any changes to the keys 44a-44l in the window 178 at the top immediately show up on the actual key displays 44a-44l (FIG. 1) of the display data entry unit 40. It is easy to drop icons or images into the Gallery 180 at the bottom using a mouse (not shown) or other input device. An integrated file browser (not shown) can be used to load image files, icons and the like into the Gallery 180. Then, it is equally easy to make images appear on display keys 44a-44l by dragging and dropping an image on a corresponding display key icon 44a-44l shown in window 178 on the screen of the host device, e.g. computer, using a mouse or other input device. As soon as the image is dropped into place on a particular key icon in window 178, the same image is displayed on the display key of the display keyboard 40 corresponding to the display key icon on which the image was dragged and dropped. In addition to drag and drop functionality, which makes it especially easy to understand and use, functions, tasks, conditional logic, web page links, macros, and the like can be assigned or otherwise associated with a particular image such that the corresponding function, task, conditional logic, web page link, and/or macro is executed or otherwise carried out when that display key is pressed sufficiently downwardly to cause its keyswitch to generate the corresponding key-press signal or code, e.g., ASCII code, for the display key. For example, a user can select and associate a particular task, function, selection, conditional logic, web page link, macro or other from a drop down menu of the layout editor with an image that can then be assigned to a particular display key, i.e. one of display keys 44a-44l, upon which it will then appear. When the display key is pressed, the associated task, function, selection, conditional logic, web page link, macro or other is caused to be executed by the host device.

A display editor 182 is used for modifying or creating new images. Again, any change to an image preferably is immediately displayed or displayable on an actual key display, preferably the display designated via the display editor. Functionality can also be assigned in the same manner as can be done as described above.

An image converter is also included that converts any image, e.g. bitmap, JPG, TIFF, etc. to a hexadecimal code representative of that image. For example, it does not matter how large the target image is in terms of size, pixels, color, black and white, grayscale, etc. Simply select a particular image or image file and perform the conversion operation on it to execute a routine that scans, parses or analyzes the target image to produce a hexadecimal code having at least one digit for each pixel of a display of a display key 44. Where greater bit depth is needed, such as where pixels are gray scale (e.g., each pixel having 0-16 levels of gray) or color (e.g., each pixel having 65,536 or greater number of colors), each key display pixel can be assigned a greater number of digits sufficient to desirably represent the target image when the conversion routine is used to create a smaller but representative image from the target image. Thereafter, the resultant smaller key display image produced is converted into digital data and transmitted when desired to the display data entry input for display on at least one display key 44 thereof.

Where each key display is of gray scale construction, each hexadecimal digit of the hexadecimal code (which has a digit for each pixel) represents a 0-16 gray scale level to which the corresponding pixel should be made lighter or darker. In such a manner, an image that is a facsimile of the much larger original target image is produce with good contrast in detail. Using such a method, entire web pages can be converted into X by Y pixel images that can be displayed on a display key 44 of a display data entry unit, graphics or other pictures embedded in a web page can be dragged-and-dropped, such as into the pixilated area of the display editor 182 to convert (or cut and paste if desired), or graphics, including digital photos, icons and the like, stored on the host device can be likewise converted.

Where the display is a color display, at least a plurality of hexadecimal digits are produced during target image conversion for each display pixel. Depending on the color bit depth desired, a plurality of pairs of hexadecimal digits are produced from the conversion routine. “Smart shortcuts” can be produced in a manner the same as or like that discussed above by assigning a desired function, task, conditional logic, web page link, and/or macro to the converted image upon or preferably before it is communicated to an actual display key for display on the display of the display key.

FIG. 33 illustrates a preferred but exemplary screen shot of a preferred software implementation of the above-described Layout Editor. The Gallery shown in FIG. 33 permits a user to drag an image stored anywhere to a particular display function key of the display key keyboard layout illustrated above the Gallery. If desired, a selected image can be edited in the Display Editor, such as by selecting the image using a mouse or the like. Clicking on pixels enables that pixel to be turned on (e.g., darkened or made black) or turned off (e.g., made lighter or transparent) in a desired manner to create a key display image as well as to edit an existing image, including one being configured for display on a display key. Once finished, the image can be stored and/or dragged and dropped onto a desired display key shown on the display key layout on screen thereby assigning that image to that particular display key. In addition, data representative of the image is produced and transmitted to the controller of the display keyboard which ultimately causes it to be displayed on the desired display key. The Navigator shown in FIG. 33 enables the user to create sets of display key images storable on the host computer which can be called up anytime, including when assigned to automatically do so by being associated with a particular software application, web page, browser, or the like, causing each one of a plurality of key display images grouped in that key display image set to be displayed on the display of the display key to which it has been pre-assigned (e.g. via image drag and drop).

FIG. 34 illustrates a keyboard simulator 184 that displays on the display screen of the host device a visual representation of the input keys of a display key equipped user input with the current display key image that is assigned to each display key being shown on the icon of that display key shown on screen. If desired, a user can use their mouse, including right-click functionality, to add, delete, reassign, etc. images to one or more of the display keys. Display key images can be built, such as by using an image editor configured in accordance with the present disclosure, which can be tested using the keyboard simulator. For example, image clarity, image appearance, any function(s) associated with an image, and other parameters can be tested or otherwise simulated before actual use with a real display keyboard constructed in accordance with the present invention.

In one preferred key display image implementation, one or more of such images can be presented or otherwise configured into a display key compatible image that is also in or compatible with MICROSOFT WINDOWS VISTA ICON format having a resolution of 256 pixels by 256 pixels. Preferably, each such display key compatible image can be presented, outputted, formatted, converted, modified or otherwise configured to have at least 20 pixel by 20 pixel resolution with each image being capable of being stored in JPG, JPEG, BMP, or PNG format.

In one preferred implementation, at least one key display compatible image is a grayscale image having a resolution of between 20 pixels by 20 pixels and 256 pixels by 256 pixels that is stored in JPEG, JPG or PNG format. In one such preferred implementation, each key display compatible image is a grayscale image having a resolution of between 20 pixels by 20 pixels and 256 pixels by 256 pixels that is stored in JPEG, JPG or PNG format.

In another preferred implementation, at least one key display image is a color image, e.g., 24-bit color, having a resolution of between 20 pixels by 20 pixels and 256 pixels by 256 pixels that is stored in JPEG, JPG or PNG format. In one such preferred implementation, each key display image is a color image of at least 8-bit color depth that has a resolution of between 20 pixels by 20 pixels and 256 pixels by 256 pixels that is stored in JPEG, JPG or PNG format.

Where the present inventions are applied to PC keyboards, suitable examples where display keys, display key circuitry, and display key software in accordance with that described above include the QWERTY keyboard, the Dvorak keyboard, mini-keyboards ranging in size having anywhere from five keys, twenty keys, thirty-five keys, sixty-five keys, etc. and other types of keyboard type data entry devices traditionally previously limited to text, e.g. ASCII, input. Keypads having a like number of display keys and the like can also be produced. Advantageously, display keys can be configured with icons, text, words, symbols, functions, including mathematical functions, flashing images, moving images, and other types of indicia, including that of non-text nature, to make data entry faster, more efficient, with less effort, and requiring less memorization. In addition, interaction with software of the host, e.g., host PC, can effect changing and/or delivery of key display images to one or more display keys of the display keyboard in response to prior user input, feedback or interaction from a network, e.g., the Internet, as well as pressing another key of the keyboard, including a display key.

In a preferred implementation of a method of configuring a website for delivering images displayable on a display key 44 of a display data entry unit, e.g. display keyboard 40, key display image related data representative of a key displayable image is embedded in the HTML or XML code of a web page. When the web page is viewed using a browser running on a device to which a display data entry unit is connected, the key display image related data is read and communicated to the display data entry unit where it is displayed or converted and displayed as at least one image on at least one display key 44.

To enable the key display image data embedded in a web page to be read, the browser is equipped with a plug-in or module, such as a BHO, which is configured to search or otherwise parse the underlying HTML or XML code of the web page being displayed in the window of the browser. Should searching reveal a code having a format that indicates it is key display image related data, the BHO reads the data such that it is downloaded and communicated to the display data entry unit, such as via its USB bus, where it is displayed on a display key 44 of the display data entry unit 40. Where necessary, the data is converted into a display image data format that is compatible with the display data entry unit 40. In one preferred implementation, the key display image related data that is embedded in the HTML or XML code in a web page is in hexadecimal format being represented by a plurality of pairs of hexadecimal digits arranged in a hexadecimal string as discussed above. If desired, data can be included in the hexadecimal string that provides display key designation information as to which key the display image data resulting from any conversion operation performed on the hexadecimal string being displayed in a specific display key 44 according to the display key designation data.

It is also to be understood that, although the foregoing description and drawings describe and illustrate in detail one or more preferred embodiments of the present invention, to those skilled in the art to which the present invention relates the present disclosure will suggest many modifications and constructions as well as widely differing embodiments and applications without thereby departing from the spirit and scope of the invention.

It is claimed:

1. A method of display data entry unit operation comprising:
(a) providing a plurality of touchable display-equipped data entry inputs linked to a device having a processor and a user readable screen;
(b) executing a software application on the device;
(c) monitoring user interaction with the software application; and
(d) causing an image displayed on at least one of the plurality of touchable display inputs to change.

2. The method of claim 1 further comprising an application program interface that communicates with the software application in step (d) to monitor user interaction with the software application.

3. The method of claim 2 wherein the application program interface is configured to monitor changes in focus of the software application and cause an image displayed in step (d) to change based on a change in focus.

4. The method of claim 2 wherein the application program interface is configured monitor mouse operation and cause an image displayed in step (d) to change based on a change in mouse operation.

5. The method of claim 4 wherein the application program interface is configured monitor mouse movement and cause an image displayed in step (d) to change based on a change in mouse movement.

6. The method of claim 5 wherein the application program interface is configured monitor a mouse selection made by the user and cause an image displayed in step (d) to change based on the context of the selection of the mouse.

7. The method of claim 6 wherein the application program interface is configured monitor a mouse selection made by the user of a menu item or selection made available to the user by the software application and cause an image displayed in step (d) to change in response thereto.

8. The method of claim 2 wherein the application program interface is configured monitor a key combination pressed by the user and cause an image displayed in step (d) to change in response thereto.

9. The method of claim 2 wherein the display data entry unit comprises a game controller, the application program comprises a game, and user interaction monitored in step (c) comprises monitoring user interaction with the game controller and causing an image displayed in step (d) to change in response to a change in operation of the game controller.

10. The method of claim 9 further comprising an application program interface that communicates with the game in step (d) to monitor user interaction with the game by monitoring changes in the game controller.

11. The method of claim 1 wherein the software application comprises a browser.

12. The method of claim 11 wherein monitoring is performed in step (d) using a plug-in or module integrated into the browser that monitors websites and cause an image displayed in step (d) to change in response to a website being browsed by the browser.

13. The method of claim 12 wherein the plug-in or module comprises a Browser Helper Object that monitors the IP address of the websites being browsed by the browser and causes an image displayed in step (d) to change in response to the IP address of the website being browsed by the browser.

14. The method of claim 12 wherein the plug-in or module comprises a Browser Helper Object that searches for embedded code in a web page being browsed by the browser and causes an image displayed in step (d) to change when data entry input display related image data is found embedded in the web page being browsed by the browser.

15. The method of claim 14 wherein the key display related image data comprises hexadecimal data that is converted in a further step into image data displayable on a display of a display-equipped data entry input.

16. The method of claim 15 comprising the further step of causing the image associated with the converted image data to be displayed on a display of a display-equipped data entry input.
